(19) United States
(12) Patent Application Publication
(10) Pub. No.: US 2025/0242332 A1
(43) Pub. Date: Jul. 31, 2025

(54) Low Temperature Methane Steam Reforming to Produce Hydrogen

(71) Applicant: Nanos Technology and Innovations Ltd., Calgary (CA)

(72) Inventors: Monica BARTOLINI TIBERI, Cochrane (CA); Gerardo VITALE ROJAS, Calgary (CA); Diego Harnan MORENO GONZALEZ, Calgary (CA); Pedro Rafael PEREIRA ALMAO, Calgary (CA)

(21) Appl. No.: 18/848,659

(22) PCT Filed: Mar. 20, 2023
(86) PCT No.: PCT/CA2023/050362

§ 371 Date: Sep. 19, 2024

Related U.S. Application Data
(60) Provisional application No. 63/321,957, filed on Mar. 21, 2022.

(51) Int. Cl. B01J 23/02; B01J 21/06; B01J 21/12; B01J 35/30; B01J 35/77; B01J 37/18; C01B 3/40

(52) U.S. Cl. CPC B01J 23/02; B01J 21/066; B01J 21/12; B01J 35/393; B01J 35/77; B01J 37/18; C01B 3/40; C01B 2203/0233; C01B 2203/04; C01B 2203/1082; C01B 2203/1241; C01B 2203/16

(57) ABSTRACT

A Low Temperature Methane Steam Reforming LTMSR catalyst is based on a non-noble metal, an alkaline earth metal and a rare earth metal combination on a support to produce stable and low temperature methane steam reforming catalysts. The catalyst is suitable for steam reforming mixtures of light hydrocarbons, such as those found in natural gas and bio-gas sources. The output may be configured to provide methane and carbon dioxide in a ratio of around 1:1 by number which is suitable for further processing into end products. The process and catalyst may help show an improved long-term performance by suppressing the fast formation of coke that is well-known to deteriorate the activity of other conventional reforming catalysts. This performance is obtained by controlling the composition and crystalline sizes of the active catalyst components on the selected support and by controlling the reaction conditions.

### RELATED APPLICATIONS

This claims priority from U.S. Provisional Application 63/321,957 filed on Mar. 21, 2022 and entitled, “Low Temperature Methane Steam Reforming to Produce Hydrogen”, the contents of which are hereby incorporated in their entirety.

### TECHNICAL FIELD

The present disclosure relates to low temperature methane steam reforming for the production of hydrogen.

### BACKGROUND

Hydrogen, an important commodity which promises to be a main energy source by the second third of this century and beyond, can be produced via a wide variety of sources.

Hydrogen ‘colors’ are widely used to denote the way it can be produced with concomitant greenhouse gas emissions, notably CO₂. Brown hydrogen is produced by gasification, for example, through steam reforming of natural gas or light hydrocarbons or coal gasification. When hydrogen is co-produced releasing CO₂ it is called grey Hydrogen, when that CO₂ co-produced is sequestered it is called Blue Hydrogen, and when it is produced with no GHG emissions it is called Green Hydrogen.

Currently over 95% of the hydrogen produced worldwide is obtained via Steam Reforming. Under this assumption hydrogen worldwide generates about 8.9 kg of CO₂ per Kg of Hydrogen, almost equivalent to the CO₂ generated by the combustion of 1 gallon of gasoline.

Steam Methane Reforming (SMR) usually accompanied with water gas shift (WGS) is one of the oldest industrial processes and the one that produces most of the hydrogen; however, as shown in the total net reaction below:

SMR+WGS: CH₄+2H₂O→4H₂+CO₂

This reaction converts the carbon present in the hydrocarbons into CO₂ during the global steam reforming process, which occurs at high temperatures and is performed in two stages, steam reforming properly, and water gas shift. Thus, even though the amount of H₂ produced is very large; there is a concomitant amount of produced CO₂ from the reaction itself and for the whole reforming process which makes this important hydrogen fuel grey colored.

Complementing the first stage of steam reforming is the water gas shift (WGS) reaction. This is performed when CO is not used directly for the synthesis of other commodity products like methanol, fuels, etc. but implemented to produce more hydrogen.

WGS: CO+H₂O→H₂+CO₂

Methane oxidation to produce syngas can be carried out with a very oxidizing agent like oxygen; however other less oxidizing agents can be used, like steam (H₂O) to do steam reforming as described above, or carbon dioxide (CO₂) to do dry reforming to produce syngas. Both approaches have pros and cons, such as high temperature level thus high energy consumption for the former, and a lower hydrogen production per carbon content of the feed for the latter.

Reasons for going to high T with SMR are both, of kinetic nature since the highest the T the highest the rate of reaction, therefore the smaller the chemical reactors with less catalyst are needed, and of thermodynamic kind since the equilibrium conversion of methane with steam into hydrogen and CO₂ becomes close to 100% at T above 680° C., when total pressure is low.

Catalytic decomposition of methane (CDM) over supported nickel catalysts is another way of producing hydrogen but in this case carbon from methane is transformed preferentially into carbon black.

CDM: CH₄→2H₂+C

Sequestering the CO₂ produced during SMR converts its hydrogen production into Blue Hydrogen, however costs associated to CO₂ transportation to the sequestering places and the availability of these places make this less environmentally harming alternative impracticable in many of the areas where hydrogen is being produced, or where it is plausibly to be produced in the future. Potential containment failures at the depths where CO₂ would be stored is also of significant concern and debated.

Green hydrogen could currently be industrially produced only via electrolysis when the source of the used electricity is not produced from fossil fuels. The source of the required electricity—including its cost and efficiency, as well as emissions resulting from electricity generation—must be considered when evaluating the benefits and economic viability of hydrogen production via electrolysis. Hydrogen production via electrolysis is being pursued for renewable (wind, solar, hydro, and geothermal) and nuclear energy options. These hydrogen production pathways result in virtually zero greenhouse gas and pollutant emissions; however, the production cost needs to be substantially decreased from where it stands nowadays ($6-8/kg) to be competitive with more mature carbon-based pathways such as natural gas reforming. Meeting the clean hydrogen cost target of $1/kg H₂ by 2030 (and interim target of $2/kg H₂ by 2025) through improved understanding of performance, cost, and durability trade-offs of electrolyzer systems under predicted future dynamic operating modes using CO₂-free electricity is a must (ENERGY.GOV). According to the DOE's Office of Energy Efficiency and Renewable Energy techno-economic analysis (DOE Hydrogen and Fuel Cells Program Record, September 2020), hydrogen could be produced at a cost around $6/kg-H₂ at present from renewable derived from modeled solar installations in Daggett, CA and Los Angeles, CA; and wind cases derived from onshore class 1 wind conditions (average wind speed 9.5 m/s) and class 6 (average wind speed 7.8 m/s). However, when compared to SMR this green hydrogen is about 3 times costlier than SMR hydrogen. It is also said that hydrogen produced by SMR of biomass renewables is considered as green hydrogen because the used feedstock took CO₂ to be formed and thus, when it is released back the cycle can continue without increasing the atmospheric CO₂, as is the case with conventional hydrocarbon feedstocks.

The idea of using the produced CO₂ instead of releasing it back into the atmosphere has always attracted attention; however, CO₂ is one of the well-known very stable molecules and, it is very difficult to activate it to produce new materials in the needed scale to make an important impact in our society. Some technologies address this issue by trying to overcome the direct production of CO₂ when using SMR by using the methane decomposition reaction CH₄→2H₂+C.

For instance, U.S. Pat. No. 10,882,743 B2 presents a process for the production of hydrogen and a separated carbon phase by contacting the hydrocarbon with a molten salt (zinc chloride, for instance) at temperatures around 500-800° C. After the reaction occurs, hydrogen without CO₂ is obtained together with a carbonaceous product recovered by lowering the temperature to about 150° C. According to the claims, the described process avoids the emission of CO₂ making the hydrogen produced in this way a zero CO₂ emission fuel (green hydrogen) with the addition of a carbon product that can have a value. It can also become negative CO₂ emissions process if the source of hydrogen were biogas.

Another technology in the same trend of methane decomposition to avoid the CO₂ produced from SMR is the one given by U.S. Pat. No. 8,092,778 B2 where the methane conversion is assisted by microwave heating producing a hydrogen rich fuel having a selected composition (15% to 20% H₂ by volume and about 80% to 85% methane by volume) and single walled carbon nanotubes over a catalyst based on Fe compounded particles from 74 μm to 140 μm (being the compounded particles FeAl, Fe₃Al, Fe₂CuAl, Fe₂NiAl, Fe₂O₃/MgO) mixed with carbon. The catalyst mixture is placed in the reactor on a microwave transparent holder configured to allow the flow of methane gas to pass through the holder and around the catalyst mixture where the microwave power is between 220 and 1000 W. The heating step is performed at a temperature between 750° C. and 900° C. The T range is as high as the one used in SMR, and one additional energy transduction from power to microwave makes less efficient reaching the reaction T needed for the process.

Finally, another technology claiming to produce hydrogen substantially free from carbon dioxide by using carbon nanotubes saturated with hydrocarbon gas or greenhouse gas is described by U.S. Pat. No. 7,468,097 B2. The description of the apparatus indicates the need of a vacuum chamber and a microwave generator aligned to discharge microwave energy that impinges on the saturated carbon nanotube having an attached hydrocarbon gas or attached greenhouse gas which was previously placed in the nanotube holding chamber. The microwave generator comprises a 500 W, 2.45 GHz magnetron tube located inside the vacuum chamber. The used catalyst is based on Fe or Mo and the temperatures achieved are in the range of 800 K to 3,500 K. As with the other existing technologies described above, the deployment of this technology in a worldwide large scale to have a real impact in GHG emission is difficult in the short term and costly in the long term.

Steam reforming is a commercial mature process which usually is carried out at high temperatures (between 750° C. to 1000° C.). Previous arts disclose the preparation of several types of steam reforming catalysts which indicates the complexity of the proposed systems and the efforts made to obtain well-dispersed and active catalysts by employing different methods of incorporating the well-known active phases for steam reforming and dispersing these active phases on different supports.

Some steam reforming catalysts are based on noble metals and/or non-noble metals where the support plays an important role for the dispersion of the active phase together with some elements which function as promoters.

Some examples are given by the patent application WO 2021/152116 A1 which teaches the production of a reforming catalyst comprising hibonite and potassium beta-alumina with improved resilience, improved activity, reduced potassium leaching and reduced coking problems.

WO 2020/230160 A1 teaches a catalyst comprising a combination of crystalline Mesoporous cellular foam (MCF) silica and basic site assistant for enhancing catalytic activity of doped active metals.

US 2019/0127220 A1 which teaches the use of a catalyst with Pd or Rh with Ni or Co supported on CeO₂ or ZrO₂ for reforming ethanol at low temperature.

U.S. Pat. No. 7,767,619 B2 discloses promoted calcium-aluminate supported catalysts for synthesis gas generation.

U.S. Pat. No. 6,808,652 B2 discloses modified e-alumina-supported nickel reforming catalyst for producing synthesis gas from natural gas.

U.S. Pat. No. 8,206,576 B2 discloses the production of a nickel-based catalyst using a hydrotalcite-like precursor and its use in the steam reforming reaction of LPG.

US 2021/0197178 A1 discloses the formulation of a high activity reforming catalyst and its use for low temperature steam reforming of hydrocarbons to produce hydrogen gas.

U.S. Pat. No. 9,393,551 B2 discloses a catalyst formulation for reforming a tar-containing gas and its method of preparation and its use for reforming tar-containing gas and the method for regenerating catalyst for reforming tar-containing gas.

US 2021/01711345 A1 discloses the possibility to use both, steam and dry reforming of methane with noble metal catalysts having Pt and Rh on cerium oxide.

US 2017/0320730 A1 discloses the integration of steam and dry reforming for syngas production with noble metal catalysts having Pt and Rh; alumina, silica and magnesia and lanthanum oxide.

Even though all of these steam reforming catalysts use noble metals like Pt, Pd and Rh and/or non-noble transition metals like Ni and Co supported on a variated of well-known oxides; the employed preparation methods as well as the way of achieving the desired dispersion play an important role making the produced catalysts different from each other.

### SUMMARY

In accordance with the present disclosure, there is provided a process for the production of hydrogen, the process comprising:
reacting hydrocarbons, including methane, and water in the presence of a steam reforming catalyst within a reaction chamber at temperatures less than 550° C. to produce carbon dioxide and hydrogen;
wherein the steam reforming catalyst comprises:
   active particles of a mixture of non-noble transition metals, alkaline earth metals and rare earth metals, the active particles having a nanocrystalline structure with domain sizes less than 25 nm, and
   a solid oxide support, and
wherein the reaction is controlled such that the number ratio between the produced carbon dioxide to the unreacted methane exiting the reaction chamber is between 0.7 and 1.4 (or between 0.9 and 1.1).

The hydrogen may be separated from the other products and unreacted reactants, and the mixture of carbon dioxide and methane is passed unto a second process to produce carbon nanofibers.

The reforming catalyst may comprise a solid support selected from the group consisting of alumina, silica, zirconia or mixtures thereof.

The solid oxide support may make up between 45% and about 90%, by mass, of the total weight of the catalyst.

The steam reforming catalyst may comprise a non-noble transition metal selected from nickel, cobalt, manganese, iron, copper or mixtures thereof.

At least a portion of the non-noble transition metals may be oxidized, and the total mass of nickel oxides, cobalt oxides, manganese oxides, iron oxides, copper oxides and zinc oxides may make up between 1% and 20%, by mass, of the total weight of the catalyst.

The steam reforming catalyst may comprise an alkali earth metal.

The alkali earth metal may comprise a combination of one or more of: magnesium, calcium, strontium and barium.

Oxides of the alkali earth metal may make up between 2% to 30%, by mass, of the total weight of the catalyst.

The steam reforming catalyst may comprise a rare earth metal.

The rare earth metal may comprise a combination of one or more of: cerium and lanthanum.

Oxides of the rare earth metal may make up between 5% and 35%, by mass, of the total weight of the catalyst.

The hydrocarbons may comprise one or more of: ethane, propane, and butane, natural gas and bio-gas.

The catalyst and process may be configured to convert a greater proportion of longer chain hydrocarbons into carbon dioxide and hydrogen than of methane (e.g., under operating conditions). The catalyst and process may be configured to convert a greater proportion of ethane than of methane (e.g., under operating conditions). The catalyst and process may be configured to convert a greater proportion of propane than of methane. The catalyst and process may be configured to convert a greater proportion of butane than of methane.

According to a further aspect of the present disclosure, there is provided a steam reforming catalyst comprising:
active particles of a mixture of non-noble transition metals, alkaline earth metals and rare earth metals, the active particles having a nanocrystalline structure with domain sizes less than 25 nm, and
a solid oxide support.

According to a further aspect of the present disclosure, there is provided a method of preparation of the catalyst as described herein, the method comprising:
providing active particles of a mixture of non-noble transition metals, alkaline earth metals and rare earth metals, the active particles having a nanocrystalline structure with domain sizes less than 25 nm;
providing a solid oxide support.

The method may comprise:
providing the solid oxide support;
providing a solution precursor of a rare earth metal to the solid oxide support; thermally treating the solution precursor to provide a modified surface on the solid oxide support; and
providing the active particles on the modified surface.

Active particles may be provided by:
treating the modified surface of the created oxide support with a solution of a mixture of salts, the salts comprising a non-noble transition metal, an alkali earth metal and a rare earth metal combined; and
thermally treating the mixture of salts to produce the active particles.

The method may comprise activating the active particles with a reducing agent.

The reducing agent may be pure hydrogen or a mixture of hydrogen and an inert gas.

The process and catalyst may be configured such that greater than 95% of each of the C₂-C₄ alkanes are converted to hydrogen and carbon dioxide while 50% or less of methane (i.e., C₁ alkane) is converted to hydrogen and carbon dioxide. The steam reforming reactor may be configured such that the conversion of methane into hydrogen and carbon dioxide can be adjusted from between 10%-50% (or between 20%-50%). This may be facilitated by: adjusting the space velocity of the gas entering the steam reforming reactor; adding, or adjusting the flow rate of, an inert gas through the reactor; adjusting the steam-to-carbon molar ratio within the steam reforming reactor, changing the reaction temperature, and/or changing the pressure within the steam reforming reactor. This may allow the same reactor to be controlled to receive different feedstocks (e.g., with different proportions of methane) and still provide a consistent output (e.g., with a carbon dioxide to unreacted methane ratio within a predetermined range).

The solid oxide support may be in the form of grains or beads. The grains or beads may have an equivalent spherical diameter of between 0.5 mm and 5 mm. The grains or beads may be substantially spherical or spheroidal.

The number ratio between the produced carbon dioxide to the unreacted methane exiting the reaction chamber may be less than 1. This may help ensure that some methane is not reacted in a subsequent dry methane reforming step. Methane may be easier to separate from the dry methane reforming products (hydrogen and carbon monoxide) than unreacted carbon dioxide.

The number ratio between the produced carbon dioxide to the unreacted methane exiting the reaction chamber may be between 0.9 and 1.0. The number ratio between the produced carbon dioxide to the unreacted methane exiting the reaction chamber may be between 0.9 and 1.1.

Unless listed otherwise, ratios given in this disclosure may be taken as number ratios. For example, a CO₂:CH₄ ratio of 0.5 means that there are two methane molecules for every molecule of carbon dioxide.

Steam reforming may be carried out at temperatures of between 480° C. to 550° C.

The attached catalyst particles are generated over the support by a careful thermal treatment after suitable solutions of metals salts are impregnated onto said support oxide material in different steps.

In the context of this disclosure, a light hydrocarbon source or feedstock may have a composition of at least 90% by mass of the following compounds: methane, butane, propane and butane. The hydrocarbons in a feedstock may comprise at least 75% methane by number.

In the context of this disclosure, the rare earth elements may comprise one or more of: scandium (Sc), yttrium (Y), and a lanthanide (Ln). A lanthanide may comprise one or more of: Lanthanum (La), Cerium (Ce), Praseodymium (Pr), Neodymium (Nd), Promethium (Pm), Samarium (Sm), Europium (Eu), Gadolinium (Gd), Terbium (Tb), Dysprosium (Dy), Holmium (Ho), Erbium (Er), Thulium (Tm), Ytterbium (Yb) and Lutetium (Lu). Lanthanum and Cerium may be preferred because they are more abundant and less expensive.

In the context of this disclosure, the alkaline earth metals are four chemical elements in group 2 of the periodic table. They are magnesium (Mg), calcium (Ca), strontium (Sr), and barium (Ba).

In the context of this disclosure, noble metals include ruthenium (Ru), rhodium (Rh), palladium (Pd), Rhenium (Rh), osmium (Os), iridium (Ir), platinum (Pt), gold (Au) and silver (Ag).

In the context of this technology, the non-noble metal may preferably include one or more of: nickel, cobalt, copper, manganese, iron and zinc.

Regarding nickel, cobalt, manganese, iron and copper catalysts, even though they show initial activities comparable to noble metal-based catalysts, they tend to deactivate very rapidly on the accounts of either carbon formation on the active phases or sintering of the active phases. Thus, the methods of preparation described herein have been designed to address these problems. In particular, these problems may be addressed by dispersing these metals inside the structure of the most stable alkaline earth oxides of Mg, Ca, Sr and Ba, and/or by adjusting the crystalline domain of the solid solution to the nano scale (e.g., lower than 25 nm). This may allow these catalysts to be used for longer, which may be important because nickel, cobalt, copper, manganese and iron are cost-effective metal active phases for commercial applications in reforming. Nickel is also well characterized as an active metal for commercial steam reforming at industrial scale.

According to another aspect of the present disclosure, there is provided a low temperature reforming catalyst which exhibit a much higher catalytic activity at low temperature as compared with existing steam reforming catalysts and has excellent durability and long-term performance by suppressing or preventing deterioration; methods to produce the catalytic formulations and low temperature methane steam reforming methods using the produced catalyst. In other embodiments of the present disclosure, the steam reforming catalysts have simplified preparation processes which are suitable for mass production; a method of preparing the same, and reforming methods of using the produced catalyst.

According to another aspect of the present disclosure, there is provided a method for preparing low temperature reforming catalysts in which the surface of the support (alumina, silica, zirconia or mixtures thereof) is modified by the incorporation of a rare earth element like cerium, lanthanum or a mixture thereof to form a crystalline rare earth oxide after a heat treatment having nanocrystalline domains below 25 nm and preparing the surface for anchoring a selected combination of active phases for optimal performance of the low temperature steam reforming of methane catalyst.

According to another aspect of the present disclosure, there is provided a method for preparing a low temperature reforming catalyst in which the surface of the support (alumina, silica, zirconia or mixtures thereof) modified with nanocrystalline domains of rare earth oxides (CeO₂, La2O₃ or mixtures thereof) is treated with a mixture of a non-noble transition metal (Ni, Co, Cu, Mn, Fe or mixtures thereof) together with alkali earth metals (Mg, Ca, Sr, Ba or mixtures thereof) and a rare earth element (Ce, La or mixtures thereof) to form a mixed crystalline oxide after a heat treatment having nanocrystalline domains below 25 nm having intimate close contact forming solid solutions that are very active and stable to perform low temperature methane steam reforming.

According to another aspect of the present disclosure, there is provided a method for activating a low temperature steam reforming catalyst in which the surface of the support (alumina, silica, zirconia or mixtures thereof) modified with nanocrystalline domains of rare earth oxides (CeO₂, La2O₃ or mixtures thereof) and modified again with a mixture of mixed crystalline oxides of rare earth (CeO₂, La2O₃ or mixtures thereof), non-noble metal (NiO, CoO, CuO, MnO, FeO or mixtures thereof) and alkali metal (MgO, CaO, SrO, BaO, or mixtures thereof) after a heat treatment having all of them nanocrystalline domain sizes below 25 nm is activated under selected conditions to be active for low temperature steam reforming reactions.

In some embodiments the nanocrystalline domain sizes may be different (e.g., 25nm or greater).

The nanocrystalline domain sizes for oxides of the non-noble transition metals may be less than 25 nm. The nanocrystalline domain sizes for oxides of the alkaline earth metals may be less than 25 nm. The nanocrystalline domain sizes for oxides of the rare earth metals may be less than 25 nm. The nanocrystalline domain sizes for metallic non-noble transition metals may be less than 25 nm (e.g., and less than 5 nm).

The nanocrystalline domain sizes may be greater than 3 nm for one or more of the metal oxides.

The catalyst may comprise a layered structure mounted on the support. The layered structure may be generated by repeatedly adding a coating of precursor solution (to the support or previous layer) and then decomposing the coated solution precursor to produce the oxides. This may be advantageous because, due to the pore volume of the support, it may not be possible to add all the desired % of metal oxides in one coating application. For example, all the required amount of salts may not dissolve in the amount of water that fills up the pore structure; thus, more water is needed to dissolve the salts and then two, three or more impregnations are required. In some cases, three layers of coating are added to reach the highest metal loading. In other examples, two layers is the best number of layers for the reaction in the conditions described below. In a multi-layer system, the catalyst may be substantially evenly distributed between the layers. E.g., in a three-layer system, each layer may have a third of the total catalyst.

Dispersion of the active catalytic phases is generally very important to achieve reaction efficiency. In this case, the inventors have found that 2-layers are sufficient to reach the best dispersion of the active phases on the support and that the third layer provides only an incremental additional benefit. Thus, the catalyst can have lower quantity of the active phases and perform similarly. Assuming that each added layer is homogeneously distributed over all the surface of the support including the coating of the pores in the support, we can conclude from the BJH pore size that each layer thickness is between 0.1 and 1nm (or between 0.2 to 0.5 nm). This corresponds to a decrease of the pore volume indicating filling space with the oxides as seen in Table 2.

According to a further aspect, there is provided a steam reforming reactor assembly comprising one or more reaction chambers, each with an inlet for receiving gaseous reactants, and an outlet for allowing gases to pass out from the reaction chamber.

The steam reforming reactor may comprise a heater for heating the reaction chamber to a temperature of between 480° C. to 550° C. The heater may comprise heating tapes. The steam reforming reactor may comprise a thermostat for controlling the temperature.

The steam reforming reactor assembly may comprise outlet sensors configured to measure the composition of the gases exiting the chamber and a controller configured to determine the ratio of carbon dioxide to unreacted methane. The controller may be configured to adjust the conditions within the reactor based on the determined number ratio between the produced carbon dioxide to the unreacted methane. Adjusting the conditions within the reactor may comprise one or more of: changing the flow rate of reactants into the reaction chamber, adjusting the temperature inside the reactor and/or injecting an inert gas with the reactants. The flow rates may be adjusted by controlling one or more pumps and valves in the lines bringing the reactants to the vessel inlet.

The reaction chamber may be configured to operate in an up-flow configuration where reactants are feed into the inlet positioned at the bottom of the reactor and products and unreacted reactants are extracted from the outlet positioned at the top.

The steam reforming reactor assembly may comprise a heater configured to convert liquid water into steam.

The reactor may be combined with a dry reforming of methane (DRM) reactor to produce an output of syngas where the number ratio between carbon monoxide and hydrogen is around 1 (e.g., between 0.7 and 1.4, or between 0.9 and 1.1).

According to a further aspect, there is provided a steam reforming reactor comprising:
multiple reaction chambers, each reaction chamber having:
   a catalyst for converting steam and hydrocarbons including methane reactants to produce hydrogen and carbon dioxide products; and
   an inlet and an outlet;
at least one gas separator configured to receive gases exiting at a first said reaction chambers, and to separate unreacted methane from the hydrogen and carbon dioxide products;
wherein a second said reaction chamber is configured to receive the separated unreacted methane from the gas separator.

Each of the multiple reaction chambers may be housed within the same heat radiating zone.

Each of the multiple reaction chambers may be configured to operate under the same conditions of pressure and temperature.

Each of the multiple reaction chambers may be configured to operate under the same conditions of Gas Hourly Space Velocity.

The outlets of each of the reaction chambers may be connected to a water separator for separating water from gases coming from the outlets of the multiple reaction chambers.

The separated water may be recycled back to the inlets of the reaction chambers after being reconverted into steam by one or more steam generators.

The catalyst may be insensitive (e.g., resistant) to acidic gas poisoning. Acidic gases may comprise sulfur containing compounds and/or nitrogen oxides (e.g., NO and/or NO₂). This may allow the initial feedstock to be fed into the steam reforming reactor without a prior desulphurisation and/or NOx removal steps. A first reaction chamber inlet may receive the hydrocarbon feed directly from the source.

The catalyst may be configured to convert longer chain hydrocarbons into hydrogen and carbon dioxide products.

The reactor may be configured to achieve a methane molar conversion of over 90%.

The reactor may comprise at least three reaction chambers.

The reactor may comprise at least three reaction chambers and multiple gas separators, wherein the reaction chambers and gas separators are arranged in series such that a gas separator is positioned between each pair of successive reaction chambers.

According to a further aspect, there is provided a method of steam reforming using the reactor described herein, the method comprising:
supplying water and hydrocarbon reactants to the reaction chambers;
reacting the supplied water and hydrocarbon reactants into carbon dioxide and hydrogen products in the reaction chambers;
separating the carbon dioxide and hydrogen products from unreacted methane from the reaction chambers; and
recycling the unreacted methane to the reaction chambers for further processing.

Within the reaction chambers, a temperature may be below 550° C. and a pressure may be in the range of 5-10 bar.

A surface area may be determined using gas absorption using the BET (Brunauer, Emmett and Teller) method (e.g. using the ISO 9277:2022 standard). The BET method may use nitrogen gas. Within the measurement of the absorption of a gas on the catalysts it is possible to determine the pore size and pore volume by applying the Barrett-Joyner-Halenda (BJH) Pore Size and Volume Analysis.

### BRIEF DESCRIPTION OF THE DRAWINGS

Various objects, features and advantages of the present disclosure will be apparent from the following description of particular embodiments of the present disclosure, as illustrated in the accompanying drawings. The drawings are not necessarily to scale, emphasis instead being placed upon illustrating the principles of various embodiments of the present disclosure. Similar reference numerals indicate similar components.

FIG. 1 is a graph of Green LTMSR-CO₂/Unreacted-CH₄ Molar Ratio vs CH₄ Conversion for an embodiment of the catalyst at 500° C.

FIG. 2 is a schematic showing Global Mass Balance using a natural gas with 94% of methane and 40% of CH₄ conversion in the LMTSR unit.

FIG. 3 is an XRD pattern of the material obtained in Example 1.

FIG. 4 is an XRD pattern of the material obtained in Example 2 (third layer).

FIG. 5 is an XRD pattern of the material obtained in Example 3 (third layer).

FIG. 6 is a schematic of the experimental apparatus for determining the effectiveness of a steam reforming catalyst.

FIG. 7 is a schematic diagram of a Low Temperature Steam Reforming reactor with multiple reaction chambers.

FIG. 8 is a schematic diagram of a Low Temperature Steam Reforming reactor which was used to test experimentally the efficiency of methane conversion.

FIG. 9 is a schematic diagram of a Low Temperature Steam Reforming reactor which was used to test the efficiency of methane conversion using a mathematical simulation.

### DETAILED DESCRIPTION

### Introduction

The present technology relates to using a low-temperature steam methane reforming (LTMSR) process to generate hydrogen while outputting carbon dioxide and methane in a ratio that is suitable for further processing into end products. The end products may be, for example, petrochemicals (e.g., ethanol) or solid carbon (e.g., in the form of carbon nanofibers) and water.

The present technology involves the use of a low-temperature steam methane reforming (LTMSR) catalyst. The LTMSR catalyst is based on a non-noble metal, an alkaline earth metal and a rare earth metal combination on a suitable support. This catalyst is suitable for steam reforming mixtures of light hydrocarbons, such as those found in natural gas and bio-gas sources, at low temperature (e.g., less than 600° C.).

The process and catalyst of the present disclosure may help provide long-term performance by suppressing the fast formation of coke that is well-known to deteriorate the activity of other conventional reforming catalysts. This performance is obtained by controlling the composition and crystalline sizes of the active catalyst components on the selected support and by controlling the reaction conditions.

The crystalline domain sizes may be controlled by adjusting one or more of the following three parameters:
the thermal temperature treatment (below 500° C.);.
the amount of the metal oxides in the composition and,.
by the solid solution mixture of the active oxide with the alkaline earth oxide.

The reaction conditions are controlled by controlling the temperature. For example, the steam reforming reaction is carried out at relatively low temperatures of below 550° C.

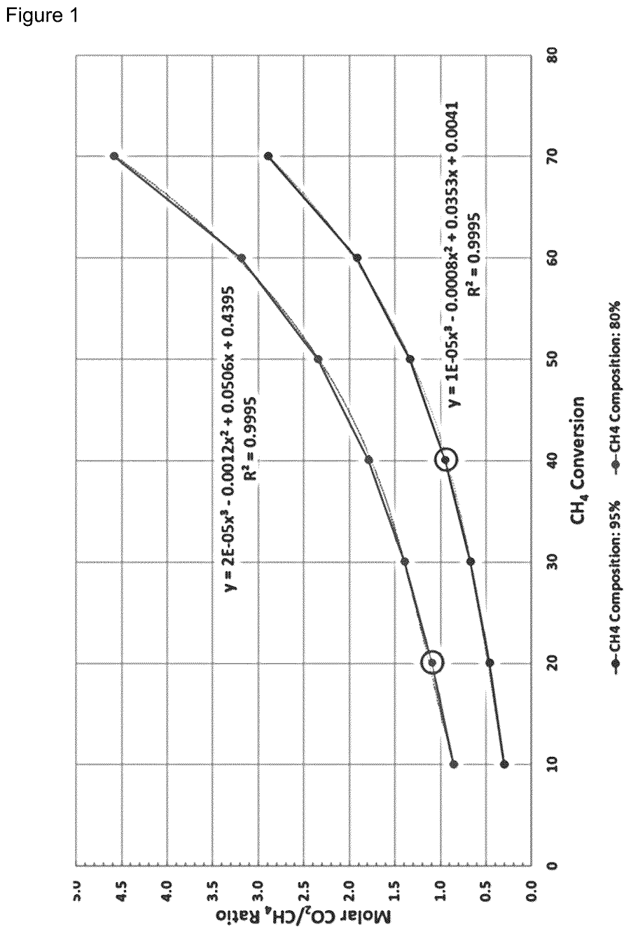

The composition of two typical natural gas feedstocks is shown in Table 1. These feedstocks may be used in conjunction with the present technology to generate hydrogen and carbon nanofibers and/or petrochemicals. Table 1 also shows the output of the reactor for different conversion ratios of methane. FIG. 1 is a graph of CO₂/Unreacted-CH₄ Molar Ratio vs CH₄ conversion for an embodiment of the catalyst at 500° C.

TABLE 1
Composition of natural gas and desired molar ratios for optimized
production of H₂ without CO₂ and its ratio with respect
to produced carbon nanofibers for two feedstocks.

| | | | | | X CH₄ | | CO₂/Unreacted | |
|---|---|---|---|---|---|---|---|---|
| Feedstock | CH₄ | C₂H₆ | C₃H₈ | C₄H₁₀ | Conv./% | H₂/CO₂ | CH₄ | H₂/CNF |
| 1 | 94.1 | 3.0 | 2.0 | 1.0 | 10 | 3.61 | 0.298 | 1.804 |
| | 94.1 | 3.0 | 2.0 | 1.0 | 20 | 3.71 | 0.461 | 1.857 |
| | 94.1 | 3.0 | 2.0 | 1.0 | 30 | 3.78 | 0.669 | 1.888 |
| | 94.1 | 3.0 | 2.0 | 1.0 | 40 | 3.81 | 0.947 | 1.907 |
| | 94.1 | 3.0 | 2.0 | 1.0 | 50 | 3.84 | 1.337 | 2.568 |
| | 94.1 | 3.0 | 2.0 | 1.0 | 60 | 3.86 | 1.921 | 3.710 |
| | 94.1 | 3.0 | 2.0 | 1.0 | 70 | 3.88 | 2.895 | 5.614 |
| 2 | 80.0 | 10.0 | 6.0 | 4.0 | 10 | 3.45 | 0.861 | 1.726 |
| | 80.0 | 10.0 | 6.0 | 4.0 | 20 | 3.51 | 1.094 | 1.922 |
| | 80.0 | 10.0 | 6.0 | 4.0 | 30 | 3.56 | 1.393 | 2.482 |
| | 80.0 | 10.0 | 6.0 | 4.0 | 40 | 3.60 | 1.792 | 3.229 |
| | 80.0 | 10.0 | 6.0 | 4.0 | 50 | 3.64 | 2.350 | 4.275 |
| | 80.0 | 10.0 | 6.0 | 4.0 | 60 | 3.67 | 3.188 | 5.844 |
| | 80.0 | 10.0 | 6.0 | 4.0 | 70 | 3.69 | 4.583 | 8.458 |

As shown in table 1, by adjusting the conversion rate of methane, the ratio CO₂ to unreacted CH₄ can be adjusted to be close to 1 (see rows in bold), which is suitable for further processing, for instance, into carbon nanofibers (see WO 2020/154799 A1).

It will be appreciated that the hydrogen to CO₂ product ratio for steam methane reforming of pure methane is 4. That is, steam reforming of pure methane produces 4molecules of hydrogen for every 1 molecule of carbon dioxide. As shown in table 1, for mixed alkane feedstock, the hydrogen to CO₂ is changed as heavier alkanes have a lower hydrogen to carbon ratio. As table 1 shows, for the situations where the CO₂/Unreacted CH₄ is close to 1, the hydrogen to CO₂ product ratio for steam methane reforming of common mixed alkane feedstocks is around 10% less than the pure methane number-i.e., between 3.8 and 3.5.

It will be appreciated that lowering the conversion rate of methane effectively increases the proportion of heavier alkanes being converted by the reactor. This means that the hydrogen to CO₂ product ratio is reduced as the conversion rate of methane is reduced.

Even for the desired CO₂/Unreacted CH₄ is close to 1, this lower ratio (of between 3.8 and 3.5, or 10% less than 4) has implications for the cost of producing hydrogen. A simple estimate would indicate that the cost of hydrogen from SMR of a mixed alkane feedstock would be around 10% higher compared with a pure methane feedstock. At the same productivity rate, if conversion of pure methane produced hydrogen at $2/kg-H₂, using a mixed feedstock as described in table 1 may produce hydrogen at $2.2/kg-H₂. This is a relatively modest increase and may be offset by the production of a very high value carbon or petrochemical product, and by allowing the use of the process for a wider range of feedstocks. Furthermore, allowing the process to operate at a lower temperature than other steam methane reforming systems, may provide energy consumption savings (e.g., of at least 20%).

Various aspects of the technology will now be described with reference to the figures and to various specific examples. For the purposes of illustration, components depicted in the figures are not necessarily drawn to scale. Instead, emphasis is placed on highlighting the various contributions of the components to the functionality of various aspects of the present disclosure. A number of possible alternative features are introduced during the course of this description. It is to be understood that, according to the knowledge and judgment of persons skilled in the art, such alternative features may be substituted in various combinations to arrive at different embodiments of the present present disclosure.

### Green Hydrogen Production

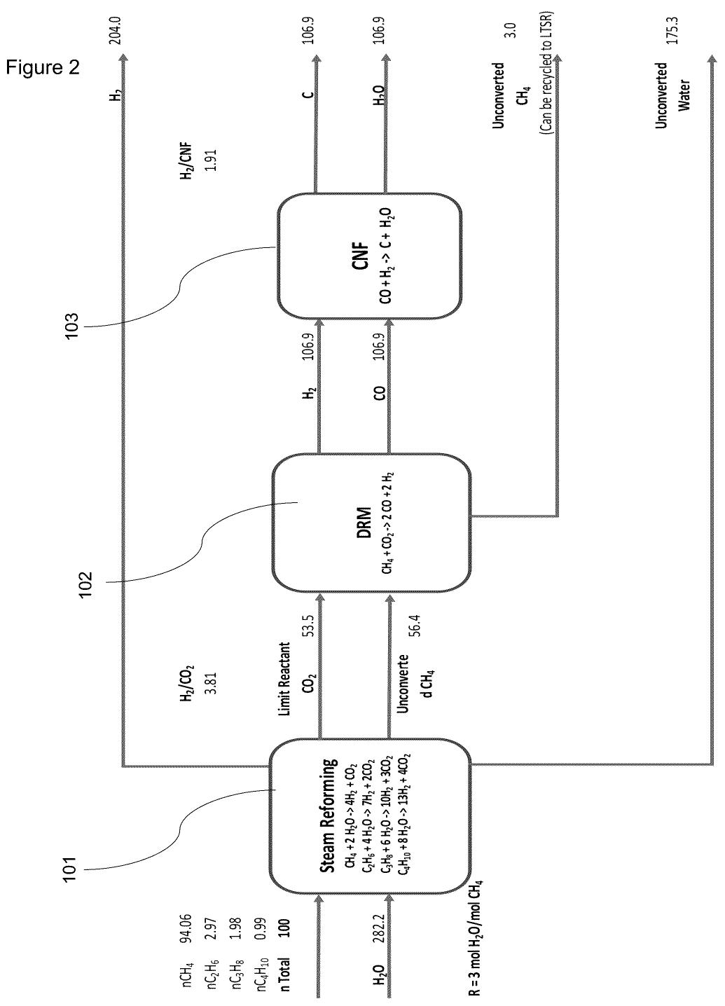

FIG. 2 is a schematic of a reactor system for producing green H₂ while simultaneously producing a path to utilize the CO₂ co-product.

The reactor system in this embodiment comprises: a steam reforming reactor 101, a dry reforming reactor 102 and a carbon nanofiber reactor 103. In other embodiments, the carbon nanofiber reactor may be replaced with a reactor configured to process the hydrogen and carbon monoxide (or syngas) to produce petrochemicals.

The proportions of the chemicals in FIG. 2 shows how the system might be used to process Feedstock 1 of Table 1. Feedstock 1 has a typical composition of natural gas containing 94% of methane (by number). Adjusting the conditions of the steam reforming reactor such that 40% of the methane is converted produces a CO₂/unreacted CH₄ number ratio at the outlet of the reactor close to 1 which represents the stoichiometry feed ratio required for dry methane reforming.

For comparison, Feedstock 2 has a lower proportion of methane and greater proportions of ethane, propane and butane than Feedstock 1. For Feedstock 2, as shown in Table 1, 20% of methane conversion in the steam reforming reactor is required to produce a CO₂/unreacted CH₄ number ratio at the outlet of the reactor close to 1. This illustrates the importance of allowing the reaction conditions within the steam reactor to be changed for different feedstocks to ensure a consistent output which can then be fed directly to the dry methane reforming reactor.

As shown in FIG. 2, the steam reforming reactor 101 is used to convert light hydrocarbons and water into hydrogen, which is extracted, and carbon dioxide. In addition, the reaction conditions are controlled such that a portion of the methane passes unreacted through the reactor.

The reactions for the various hydrocarbons within the steam reforming reactor are as follows:

Methane: CH₄+2H₂O→4H₂+CO₂

Ethane: C₂H₆+4H₂O→7H₂+2CO₂

Propane: C₃H₈+6H₂O→10H₂+3CO₂

Butane: C₄H₁₀+8H₂O→13H₂+4CO₂

The steam reforming reactor, in this case, comprises a vessel comprising a steam reforming catalyst as described in greater detail below. The steam reforming catalyst comprises active particles of a mixture of non-noble transition metals, alkaline earth metals and rare earth metals, the active particles having a nanocrystalline structure with domain sizes less than 25 nm, and a solid oxide support. Generally, the metallic nickel has crystalline domains lower than 7 nm the Ce³⁺ and Ce⁴⁺ are in the same CeO₂ structure that has crystalline domain sizes below 25 nm. After activation, the metallic nickel may be on the mixed oxides top that are in the support.

In this case, the steam reforming catalyst is configured to convert a greater proportion of the longer chain hydrocarbons (e.g., ethane, propane and butane) than of methane. This means that a mixed hydrocarbon feedstock can be processed through the steam reforming reactor to increase the ratio of methane with respect to the other hydrocarbons in the feedstock. This may help improve the consistency of the feedstock being provided to the next stage in the process, as compared to directing a portion of the feedstock directly into the next stage.

In this example, water in the form of steam is injected into the steam reforming reactor in excess. In this case, 3 moles of water are injected for every mole of methane. As shown in the reactions provided above, two mols of water are required to convert 1 mol of methane into hydrogen and carbon dioxide in the steam reforming process. Although there are other hydrocarbons in this feedstock, they make up a relatively small proportion so a steam/methane number ratio of 3:1 corresponds to excess steam. The unreacted water is also separated from the other gases passing through the reactor (e.g., by being condensed and separated as a liquid).

As noted above, the hydrogen produced by the steam reforming reactions is removed using a membrane.

In this embodiment, the reaction conditions are controlled such that the proportion of the unconverted methane exiting the chamber is roughly in the same proportion as the produced carbon dioxide from all the various steam reforming reactions occurring within the vessel. In this case, this can be done by adjusting the space velocity passing through the reactor. Increasing the space velocity reduces the conversion rate of methane passing through the reactor.

In this system, the carbon dioxide product of the steam reforming and the unconverted methane are injected into a dry methane reforming reactor 102. The dry methane reforming reactor comprises a vessel with a dry reforming catalyst and is configured to convert the carbon dioxide and methane into hydrogen and carbon monoxide:

CH₄+CO₂→2H₂+2CO

In this case, the hydrogen is not separated from the other reactants, but instead is passed with the carbon monoxide to the final stage in the process. In this embodiment over 90% by number of the methane molecules injected into the dry reforming reactor is converted. Any excess is separated from the reactants and recycled, in this case, to the steam reforming reactor. Having a small excess of methane in the dry reforming reactor may help ensure that an excess of carbon dioxide does not pass through the dry methane reforming. This may facilitate the separation of unwanted reactants from the products of the dry reforming process.

In this system, the conditions of the dry methane reforming reactor are configured to convert the majority of the methane and carbon dioxide into the hydrogen and carbon monoxide products.

In the final stage, the hydrogen and carbon monoxide produced in the dry reforming reactor is passed into a carbon nanofiber reactor 103. This comprises a vessel comprising a nanofibre catalyst for producing carbon nanofibers. This reactor allows the conversion of equal volumes or numbers of hydrogen and carbon monoxide into carbon nanofibers and water:

H₂+CO→C+H₂O

The water may be recycled for steam reforming.

The overall process, in this case, produces no carbon dioxide because the carbon dioxide produced in the steam reforming reactor is subsequently used to produce solid carbon in the form of carbon nanofibers. Assuming a feedstock of pure methane, the overall reaction for the process is as follows:

Steam Reforming (+passing CH₄): CH₄+2H₂O (+CH₄)→4H₂+CO₂ (+CH₄)

Dry methane reforming: CH₄+CO₂→2H₂+2CO

Carbon Production: 2H₂+2CO→2C+2H₂O

Overall reaction: 2CH₄→4H₂+2C

This technology allows green hydrogen production using SMR with a much lower temperature. This may improve the economics of the steam reforming process, provide a cleaner use for existing hydrocarbon reserves (such as natural gas), produce a useful carbon nanomaterial, and reduce the GHG emissions of current industrial practice.

The produced syngas also can be used for production of petrochemicals of high value. Some produced hydrogen can be redirected to increase the H₂/CO ratio of the produced syngas for selective production of methanol, formic acid, ethanol, etc.

### Catalyst

As described above, the steam reforming catalyst comprises:
active particles of a mixture of non-noble transition metals, alkaline earth metals and rare earth metals, the active particles having a nanocrystalline structure with domain sizes less than 25 nm, and
a solid oxide support.

The rare earth elements may comprise one or more of: scandium (Sc), yttrium (Y), and a lanthanide.

The alkaline earth metals may comprise one or more of: magnesium (Mg), calcium (Ca), strontium (Sr), and barium (Ba).

The noble metals include ruthenium (Ru), rhodium (Rh), palladium (Pd), Rhenium (Rh), osmium (Os), iridium (Ir), platinum (Pt), gold (Au) and silver (Ag). Therefore, a non-noble transition metal may include one or more of: nickel, cobalt, manganese, iron and copper.

The solid oxide support may comprise one or more of: alumina, silica and zirconia. The mass proportions of the catalyst may be as follows:
solid oxide support: 45%-90%;
oxides of the non-noble transition metals (e.g., NiO, Ni₂O₃, CoO, Co₂O₃ Co₃O₄, MnO, Mn₂O₃, Mn₃O₄, CuO, Cu₂O, FeO, Fe₂O₃, Fe₃O₄ and/or ZnO): 1%-20%;
alkali earth metal: 2%-30%; and
oxides of the rare earth metal: 5%-35%.

Regarding the size of the nanocrystalline domain size, the sizes may be considered to relate to an “average three-dimensional size” as there is no apparent preferential orientation of the oxides in the X-ray diffraction pattern and all the crystalline planes of the oxide structures correspond to values of less than 25 nm.

The size of the nanocrystalline domain size is calculated using the Scherrer equation (e.g., via x-ray diffraction, XRD). The dimension is an average of the different crystalline planes which in all the planes for these catalysts may be lower than 25 nm. The inventors have found that for these catalysts, there is not a visible preferential growth of the crystals in the X-ray diffraction pattern. The conventional shape factor of 0.9 is used as implemented in the software.

After activation, the metals are generally present in the form of oxides. The only two that after activation can have a metallic component are the non-noble transition metals (e.g., nickel and copper). Most of the nickel will be in an oxide form NiO mixed in a solid solution with MgO with a small part being a very tiny metallic cluster. The CeO₂ will have some parts of the cerium as Ce⁴⁺ (more abundant) and Ce³⁺ less abundant but the two of them in the same CeO₂ structure.

Catalyst Examples

The low temperature reforming catalysts of the present disclosure, their preparation methods and their use for low temperature steam reforming of light hydrocarbons, natural gas and bio-oils will be better understood by reference to the following examples.

The raw materials used for the preparation of the materials referenced in the examples were obtained from Sigma Aldrich™ and Sasol™; these are: cerium nitrate hexahydrate (Ce(NO₃)₃·6H₂O), nickel nitrate hexahydrate (Ni(NO₃)₂·6H₂O), magnesium nitrate hexahydrate (Mg(NO₃)₂·6H₂O), cobalt nitrate hexahydrate (Co(NO₃)₂·6H₂O), copper nitrate hemi (pentahydrate) (Cu(NO₃)₂·2.5H₂O), manganese nitrate hexahydrate (Mn(NO₃)₂·6H₂O), calcium nitrate tetrahydrate (Ca(NO₃)₂·4H₂O), iron(II) sulfate heptahydrate (FeSO₄·7H₂O), Lanthanum nitrate hexahydrate (La(NO₃)₃·6H₂O) and gamma-alumina (γ-Al₂O₃) spheres of 1 mm diameter.

The examples show the preparation of some useful low temperature reforming catalysts of the present disclosure as well as the activation of the materials of the present disclosure and its use as catalysts for the low temperature reforming of light hydrocarbons, natural gas or bio-oil. These experiments are cited only as examples it will be appreciated that other variations would be possible.

These Examples relate to results obtained in a continuous steam reforming reactor working at a Steam/C Molar Ratio=5 and P=30 psig are described below for our catalyst performing at a mass space velocity of 1300 h⁻¹ generating a conversion higher than 70% of methane when this reactant is in the range of concentrations between 94% and 80% volume content of the hydrocarbon feedstock. The temperature used is in the range of 500-550° C., which is about 300° C. lower than conventional SMR. These features provide a significant and original advantage by reducing the energy consumption of SMR by up to 35%, while using the same SMR infrastructure installed worldwide.

The steam reforming catalyst described herein can operate at 5-20 times that space velocity to achieve the lowest methane conversion (40% to 20% as per table 1) required to match the desired CO₂/unreacted CH₄ proportion of around 1. Therefore, this provides a much higher productivity, comparable to the SMR at conventional high temperature. For comparison, it will be appreciated that for a pure methane feedstock, a conversion rate of 50% would be required to ensure that the output of the steam reforming reactor has a CO₂/unreacted CH₄ proportion of around 1.

This confirms the possibility of simply retrofitting existing SMR units, and adding the carbon nanofiber production stages.

Table 2 below shows the XRD domain sizes and textural properties of the various layers of three examples. These materials were also used in the testing of the catalytic properties for low temperature steam reforming of the present technology.

The proportions by mass of the components in these three catalysts are:
1st-layer: % Al₂O₃=81.6; % CeO₂=13.2; % NiO=2.2 and % MgO=3.0 with a Ni/Ce atomic ratio of 0.38; a Mg/Ni atomic ratio of 2.5 and a Mg/Ce atomic ratio of 0.96.
2nd-layer: % Al₂O₃=76.1; % CeO₂=14.3; % NiO=4.1 and % MgO=5.5 with a Ni/Ce atomic ratio of 0.65; a Mg/Ni atomic ratio of 2.5 and a Mg/Ce atomic ratio of 1.65.
3rd-layer: % Al₂O₃=71.2; % CeO₂=15.3; % NiO=5.7 and % MgO=7.8 with a Ni/Ce atomic ratio of 0.86; a Mg/Ni atomic ratio of 2.5 and a Mg/Ce atomic ratio of 2.2.

TABLE 2
XRD average crystalline domain sizes and textural properties
of the produced materials of Examples 1-3.

| | XRD average crystalline | | | | | | External | BJH Pore | |
|---|---|---|---|---|---|---|---|---|---|
| | domain sizes [nm] | | | | BET area | Micro area | area | volume | BJH Pore |
| Sample | CeO₂ | NiO | MgO | Ni | [m²/g] | [m²/g] | [m²/g] | [cm³/g] | size [nm] |
| Example 1 | 7.9 | — | — | — | 131.4 | 6.5 | 124.9 | 0.3833 | 8.12 |
| Example 2 | 8.3 | 5.6 | 5.6 | — | 124.5 | 10.9 | 113.6 | 0.3310 | 7.89 |
| (1^{st}-layer) | | | | | | | | | |
| Example 2 | 8.9 | 5.6 | 5.6 | — | 118.3 | 9.2 | 109.1 | 0.2931 | 7.72 |
| (2^{nd}-layer) | | | | | | | | | |
| Example 2 | 8.9 | 5.7 | 5.7 | — | 116.6 | 8.9 | 107.7 | 0.2707 | 7.24 |
| (3^{rd}-layer) | | | | | | | | | |
| Example 3 | 8.7 | 3.7 | 3.7 | <2 | 117.3 | 8.7 | 108.5 | 0.3530 | 8.04 |
| (1^{st}-layer) | | | | | | | | | |
| Example 3 | 8.7 | 5.3 | 5.3 | <2 | 102.3 | 9.5 | 92.8 | 0.3098 | 7.89 |
| (2^{nd}-layer) | | | | | | | | | |
| Example 3 | 9.3 | 6.1 | 6.1 | <3 | 89.5 | 12.2 | 77.3 | 0.2609 | 7.56 |
| (3^{rd}-layer) | | | | | | | | | |

### Example 1: Modification of the Alumina Surface With CeO₂

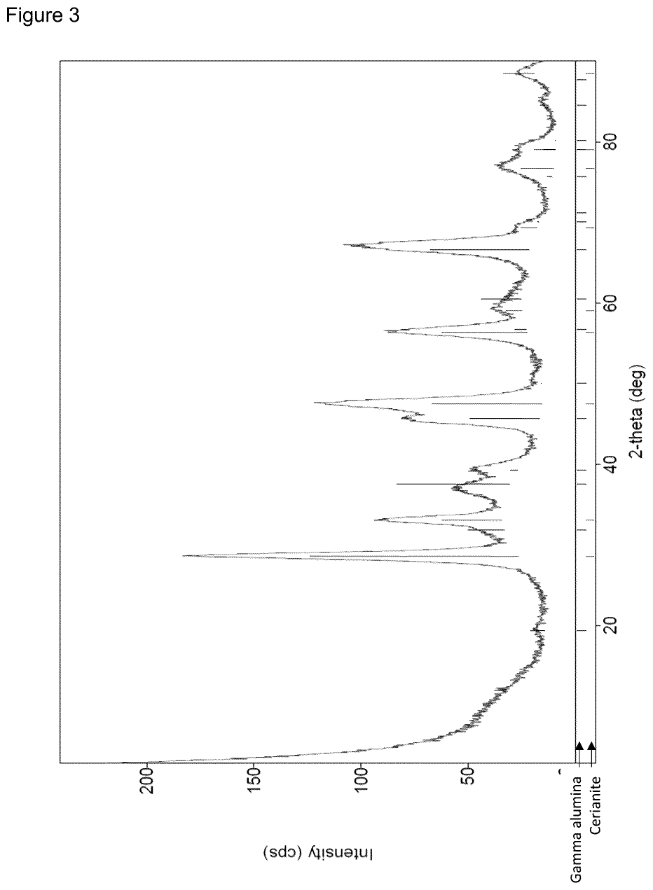

A solution of cerium nitrate was prepared by dissolving 248 grams of cerium nitrate in 270 mL of deionized water. This solution was added to the dispenser to be added with a flow of 10 mL/min under the air nozzle over 720 grams of γ-Al₂O₃ spheres contained inside of the pan of the impregnating machine (or coating machine) which was rotating at 30 rpm. After the solution was added, the impregnated spheres were allowed to rotate for 30 minutes at 30 rpm; after this time, hot air was introduced in the pan chamber for 30minutes. The impregnated spheres were transferred to stainless steel trays and placed in the oven to dry them at 100° C. for 3 hours and then calcined at 400° C. for 12 hours with a ramp of 5° C./min. FIG. 3 and Table 2 show the XRD pattern of the calcined material and the average crystalline domain sizes measured by XRD as well as its textural properties, respectively.

### Example 2: Incorporation of NiO, MgO and CeO₂ on the CeO₂-Modified Alumina

A solution of nickel nitrate, magnesium nitrate and cerium nitrate was prepared by dissolving 225 grams of nickel nitrate, 140 grams of cerium nitrate and 500 grams of magnesium nitrate in 580 mL of deionized water. The obtained solution was divided in three portions to be added by three successive impregnations as follows:

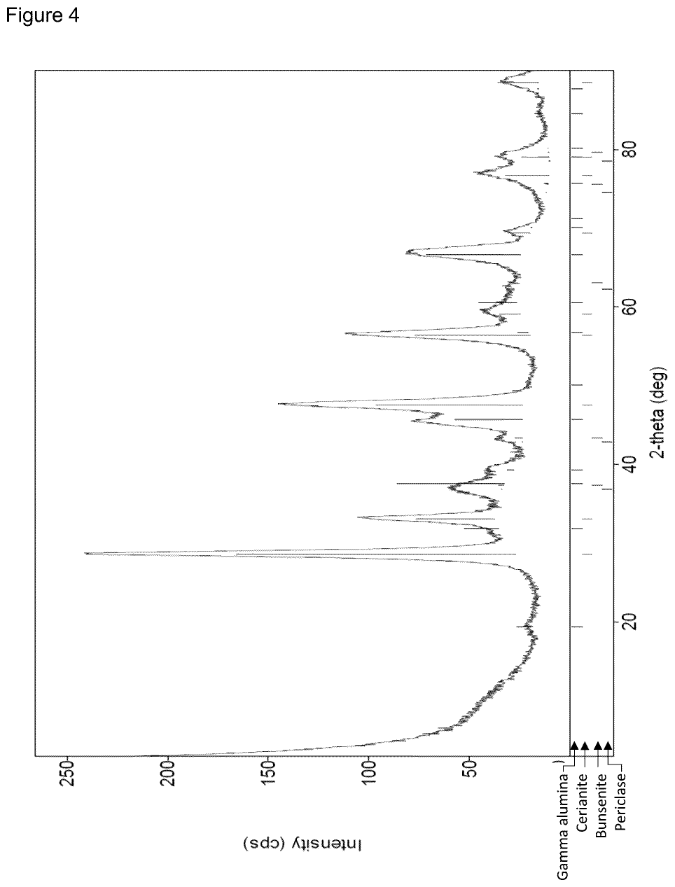

818 grams of the produced CeO₂-modified alumina were incorporated inside the impregnator's pan and rotated at 30 rpm. The first portion of the mixed metal solution was added to the dispenser and flowed at a rate of 10 mL/min under the air nozzle. After the solution was added, the impregnated spheres were allowed to rotate for 30 minutes at 30rpm; after this time, hot air was introduced in the pan chamber for 50 minutes. The impregnated spheres were transferred to stainless steel trays and place in the oven to dry them at 100° C. for 3 hours and then calcine them at 400° C. for 12 hours with a ramp of 5° C./min producing in this way Example 2 1^{st}-layer. After the spheres were calcined, they were placed back into the impregnator's pan to carry out the second impregnation with the second portion of the solution using the same protocol of the first impregnation producing in this way Example 2 2^{nd}-layer. After the calcination, the produced material was again placed inside the impregnator's pan and its impregnation was carried out in the same fashion with the last portion of the solution producing in this way Example 2 3^{rd}-layer. FIG. 4 and Table 2 show the XRD pattern of the calcined material and the average crystalline domain sizes measured by XRD as well as its textural properties, respectively.

The final temperature is an important parameter for determining the nanocrystalline domain sizes we are targeting. The higher the temperature the higher the nanocrystalline domain sizes will be but after 700° C. the oxides will begin to react with the alumina to form spinel mixed oxides which are not easy to reduce and require a high temperature to obtain the metallic nickel. The presently disclosed method of producing the catalyst ensures that the nickel is available for reduction but not all of it as we require very small crystalline domain sizes.

The temperature ramp can also influence the diffusion of the gases produced by the decomposition of the salts used to impregnate the support. A very fast ramp may be an inferior choice because the gases produced by decomposition of the salts generate a high pressure within the support that can break or damage the alumina spheres.

In general, the dried impregnated spheres are heated to a temperature of at least 450° C. for at least 6 hours with a ramp of no more than 15° C./min.

### Example 3: Activation of the Catalyst of Example 2 for Steam Reforming

The activation of the catalyst generally must be performed in situ within the steam reforming reactor and, to obtain the best performance, it is advised to carry it out right before the run with the selected feedstock to avoid any possible pre-oxidation of the active sites.

Before starting the activation protocol, in this case, the system is purged with an inert gas (such as nitrogen), and then with hydrogen to move the air out of the unit.

For this purpose, nitrogen is flowed through the reactor at 100 mL/min during at least 30 minutes or until no oxygen is detected anymore by Gas Chromatography (GC) and/or Quadrupole Mass Spectrometry (QMS). Then, the nitrogen gas is changed to hydrogen gas, which is flowed through the reactor at 100 mL/min during few hours (e.g. 5hours or more) or until no nitrogen is detected anymore by Gas Chromatography (GC) and/or Quadrupole Mass Spectrometry (QMS).

To start the reduction, hydrogen is flowed through the reactor filled with the catalyst at 100 mL/min and atmospheric pressure, the temperature is increased from room temperature to 500° C. with a ramp of 10° C./min. After the temperature of 500° C. is reached, the system is pressurized at 86 psig. The produced mixture of gases generated during the activation process was followed by a Quadrupole Mass Spectrometry (QMS) to check on the profile of the produced gases which is going to indicate the end of the activation protocol when hydrogen is stabilized (not consumed/produced) and the other gases reach background levels. The temperature is maintained at 500° C. for approximately 16 hours. This time may have to be adjusted if the used pressure is lower than 86 psig and, of course, based on the results obtained by the QMS.

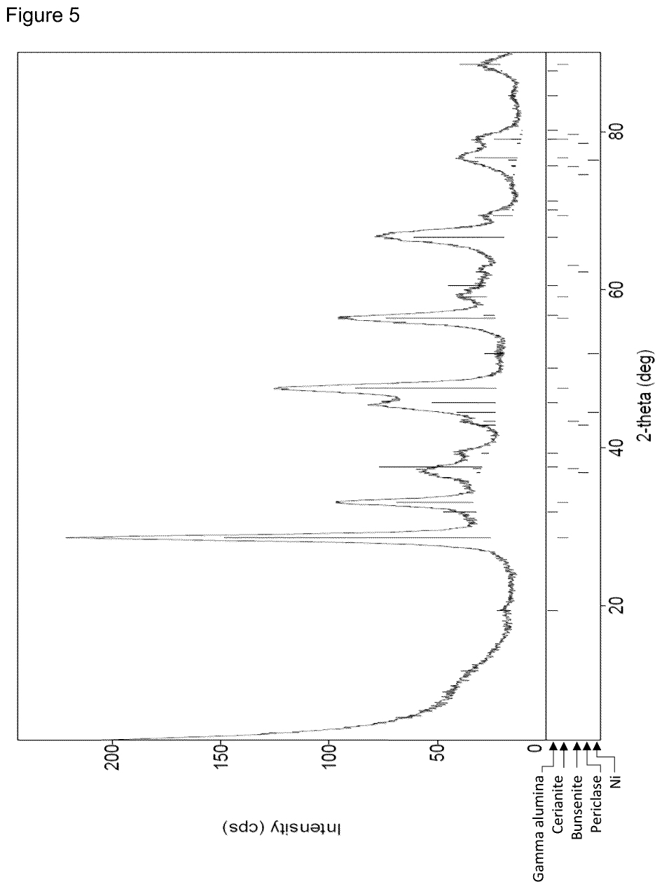

FIG. 5 and Table 2 shows the XRD powder diffraction pattern of a sample of the activated material and the average crystalline domain sizes measured by XRD as well as its textural properties, respectively. In this case, the final catalyst composition comprises: CeO₂, NiO, MgO and Ni. That is, the non-noble transition metal is nickel, the alkaline earth metal is magnesium, and the rare earth metal is Cerium.

The mass proportions of the components in this catalyst are % Al₂O₃=71.2; % CeO₂=15.3; % NiO=5.7 and % MgO=7.8 with a Ni/Ce atomic ratio of 0.86; a Mg/Ni atomic ratio of 2.5 and a Mg/Ce atomic ratio of 2.2.

### Additional Catalyst Examples

The raw materials used for the preparation of the materials referenced in the examples were obtained from Sigma Aldrich™ and Sasol™; these are: cerium nitrate hexahydrate (Ce(NO₃)₃·6H₂O), nickel nitrate hexahydrate (Ni(NO₃)₂·6H₂O), magnesium nitrate hexahydrate (Mg(NO₃)₂·6H₂O), cobalt nitrate hexahydrate (Co(NO₃)₂·6H₂O), copper nitrate hemi (pentahydrate) (Cu(NO₃)₂·2.5H₂O), manganese nitrate hexahydrate (Mn(NO₃)₂·6H₂O), calcium nitrate tetrahydrate (Ca(NO₃)₂·4H₂O), iron(II) sulfate heptahydrate (FeSO₄·7H₂O), Lanthanum nitrate hexahydrate (La(NO₃)₃·6H₂O) and gamma-alumina (γ-Al₂O₃) spheres of 1 mm diameter.

### Example 4: Modification of the Alumina Surface With CeO₂ to Prepare Other Variations of the Catalysts of the Present Present Disclosure

A solution of cerium nitrate was prepared by dissolving 104 grams of cerium nitrate in 122 mL of deionized water. This solution was added to the dispenser to be added with a flow of 10 mL/min under the air nozzle over 300 grams of γ-Al₂O₃ spheres contained inside of the pan of the impregnating machine (or coating machine) which was rotating at 30 rpm. After the solution was added, the impregnated spheres were allowed to rotate for 30 minutes at 30 rpm; after this time, hot air was introduced in the pan chamber for 30 minutes. The impregnated spheres were transferred to stainless steel trays and placed in the oven to dry them at 100° C. for 3 hours and then calcined at 400° C. for 12 hours with a ramp of 5° C./min. Table 3 show the average crystalline domain sizes measured by XRD as well as its textural properties, respectively.

### Example 5: Incorporation of Co₃O₄, MgO and CeO₂ on the CeO₂-Modified Alumina of Example 4

A solution of cobalt nitrate, magnesium nitrate and cerium nitrate was prepared by dissolving 13.748 grams of cobalt nitrate, 8.649 grams of cerium nitrate and 30.674 grams of magnesium nitrate in 47.7 mL of deionized water. The obtained solution was divided in three portions to be added by three successive impregnations as follows:

50 grams of the produced CeO₂-modified alumina of Example 4 were incorporated inside the impregnator's pan and rotated at 30 rpm. The first portion of the mixed metal solution was added to the dispenser and flowed at a rate of 10 mL/min under the air nozzle. After the solution was added, the impregnated spheres were allowed to rotate for 10minutes at 30 rpm; after this time, hot air was introduced in the pan chamber for 10minutes. The impregnated spheres were transferred to stainless steel trays and place in the oven to dry them at 100° C. for 3 hours and then calcine them at 400° C. for 12 hours with a ramp of 5° C./min producing in this way Example 5 1^{st}-layer. After the spheres were calcined, they were placed back into the impregnator's pan to carry out the second impregnation with the second portion of the solution using the same protocol of the first impregnation. After the calcination producing in this way Example 5 2^{nd}-layer, the produced material was again placed inside the impregnator's pan and its impregnation was carried out in the same fashion with the last portion of the solution producing in this way Example 5 3^{rd}-layer. Table 3 shows the average crystalline domain sizes measured by XRD as well as its textural properties, respectively.

### Example 6: Activation of the Catalyst of Example 5 for Steam Reforming

The activation of the catalysts of Example 5 was carried out in the same fashion as those of Example 3. Table 3 shows the average crystalline domain sizes measured by XRD as well as its textural properties, respectively. In this case, the final catalyst composition comprises: CeO₂, Co₃O₄, and MgO. That is, the non-noble transition metal is cobalt, the alkaline earth metal is magnesium, and the rare earth metal is Cerium.

The mass proportions of the components in these three catalysts are:
1^{st}-layer: % Al₂O₃=81.6; % CeO₂=13.2; % CoO=2.2 and % MgO=3.0 with a Co/Ce atomic ratio of 0.38; a Mg/Co atomic ratio of 2.5 and a Mg/Ce atomic ratio of 0.96.
2^{nd}-layer: % Al₂O₃=76.0; % CeO₂=14.3; % CoO=4.1 and % MgO=5.6 with a Co/Ce atomic ratio of 0.65; a Mg/Co atomic ratio of 2.5 and a Mg/Ce atomic ratio of 1.65.
3^{rd}-layer: % Al₂O₃=71.2; % CeO₂=15.3; % CoO=5.7 and % MgO=7.8 with a Co/Ce atomic ratio of 0.86; a Mg/Co atomic ratio of 2.5 and a Mg/Ce atomic ratio of 2.2.

TABLE 3
XRD average crystalline domain sizes and textural properties
of the produced materials of Examples 4, 5 and 6.

| | XRD average crystalline | | | | | | External | BJH Pore | |
|---|---|---|---|---|---|---|---|---|---|
| | domain sizes [nm] | | | | BET area | Micro area | area | volume | BJH Pore |
| Sample | CeO₂ | Co₃O₄ | MgO | Co | [m²/g] | [m²/g] | [m²/g] | [cm³/g] | size [nm] |
| Example 4 | 8.4 | — | — | — | 137.3 | 10.4 | 126.9 | 0.3787 | 7.84 |
| Example 5 | 8.4 | 5.6 | 5.9 | — | 119.4 | 10.5 | 108.8 | 0.3325 | 7.99 |
| (1^{st}-layer) | | | | | | | | | |
| Example 5 | 8.9 | 6.3 | 6.8 | — | 119.5 | 7.5 | 112.0 | 0.3142 | 7.71 |
| (2^{nd}-layer) | | | | | | | | | |
| Example 5 | 8.8 | 17.0 | 8.6 | — | 101.5 | 4.9 | 96.6 | 0.2600 | 7.37 |
| (3^{rd}-layer) | | | | | | | | | |
| Example 6 | 8.7 | 4.7 | 2.7 | — | 119.5 | — | 119.5 | 0.3995 | 8.92 |
| (1^{st}-layer) | | | | | | | | | |
| Example 6 | 8.7 | 4.7 | 10.0 | — | 105.7 | 8.4 | 97.3 | 0.3029 | 7.94 |
| (2^{nd}-layer) | | | | | | | | | |
| Example 6 | 8.9 | 6.7 | 6.6 | — | 90.3 | 8.1 | 82.2 | 0.2752 | 7.82 |
| (3^{rd}-layer) | | | | | | | | | |

### Example 7: Incorporation of CuO, MgO and CeO₂ on the CeO₂-Modified Alumina of Example 4

A solution of copper nitrate, magnesium nitrate and cerium nitrate was prepared by dissolving 11.041 grams of copper nitrate, 8.660 grams of cerium nitrate and 30.751 grams of magnesium nitrate in 47.7 mL of deionized water. The obtained solution was divided in three portions to be added by three successive impregnations as follows:

50 grams of the produced CeO2-modified alumina of Example 4 were incorporated inside the impregnator's pan and rotated at 30 rpm. The first portion of the mixed metal solution was added to the dispenser and flowed at a rate of 10 mL/min under the air nozzle. After the solution was added, the impregnated spheres were allowed to rotate for 10 minutes at 30 rpm; after this time, hot air was introduced in the pan chamber for 10 minutes. The impregnated spheres were transferred to stainless steel trays and place in the oven to dry them at 100° C. for 3 hours and then calcine them at 400° C. for 12 hours with a ramp of 5° C./min producing in this way Example 7 1^{st}-layer. After the spheres were calcined, they were placed back into the impregnator's pan to carry out the second impregnation with the second portion of the solution using the same protocol of the first impregnation. After the calcination, producing in this way Example 7 2^{nd}-layer, the produced material was again placed inside the impregnator's pan and its impregnation was carried out in the same fashion with the last portion of the solution producing in this way Example 7 3^{rd}-layer. Table 4 shows the average crystalline domain sizes measured by XRD as well as its textural properties, respectively.

### Example 8: Activation of the Catalyst of Example 7 for Steam Reforming

The activation of the catalysts of Example 7 was carried out in the same fashion as those of Example 3. Table 4 shows the average crystalline domain sizes measured by XRD as well as its textural properties, respectively. In this case, the final catalyst composition comprises: CeO₂, CuO, MgO and Cu. That is, the non-noble transition metal is copper, the alkaline earth metal is magnesium, and the rare earth metal is Cerium.

The mass proportions of the components in these three catalysts are:
1^{st}-layer: % Al₂O₃=81.4; % CeO₂=13.3; % CuO=2.3 and % MgO=3.0 with a Cu/Ce atomic ratio of 0.38; a Mg/Cu atomic ratio of 2.5 and a Mg/Ce atomic ratio of 0.96.
2^{nd}-layer: % Al₂O₃=75.8; % CeO₂=14.3; % CuO=4.3 and % MgO=5.6 with a Cu/Ce atomic ratio of 0.65; a Mg/Cu atomic ratio of 2.5 and a Mg/Ce atomic ratio of 1.65.
3^{rd}-layer: % Al₂O₃=70.9; % CeO₂=15.2; % CuO=6.1 and % MgO=7.8 with a Cu/Ce atomic ratio of 0.86; a Mg/Cu atomic ratio of 2.5 and a Mg/Ce atomic ratio of 2.2.

TABLE 4
XRD average crystalline domain sizes and textural properties
of the produced materials of Examples 7 and 8.

| | XRD average crystalline | | | | | | External | BJH Pore | |
|---|---|---|---|---|---|---|---|---|---|
| | domain sizes [nm] | | | | BET area | Micro area | area | volume | BJH Pore |
| Sample | CeO₂ | CuO | MgO | Cu | [m²/g] | [m²/g] | [m²/g] | [cm³/g] | size [nm] |
| Example 7 | 8.4 | 5.6 | 1.9 | — | 129.1 | 10.0 | 119.1 | 0.3657 | 8.01 |
| (1^{st}-layer) | | | | | | | | | |
| Example 7 | 8.4 | 5.0 | 2.4 | — | 100.8 | 10.0 | 90.8 | 0.3133 | 7.73 |
| (2^{nd}-layer) | | | | | | | | | |
| Example 7 | 8.4 | 5.0 | 3.6 | — | 109.4 | 8.4 | 101.0 | 0.2984 | 7.62 |
| (3^{rd}-layer) | | | | | | | | | |
| Example 8 | 8.5 | — | 3.8 | 5.4 | 117.6 | — | 117.6 | 0.4205 | 8.04 |
| (1^{st}-layer) | | | | | | | | | |
| Example 8 | 8.4 | — | 4.6 | 5.5 | 100.7 | 5.7 | 95.0 | 0.2924 | 7.95 |
| (2^{nd}-layer) | | | | | | | | | |
| Example 8 | 8.5 | — | 4.9 | 10.3 | 93.7 | 8.7 | 85.0 | 0.2765 | 7.85 |
| (3^{rd}-layer) | | | | | | | | | |

### Example 9: Incorporation of MnO, MgO and CeO₂ on the CeO₂-Modified Alumina of Example 4

A solution of manganese nitrate, magnesium nitrate and cerium nitrate was prepared by dissolving 11.826 grams of manganese nitrate, 8.594 grams of cerium nitrate and 30.556 grams of magnesium nitrate in 47.7 mL of deionized water. The obtained solution was divided in three portions to be added by three successive impregnations as follows:

50 grams of the produced CeO₂-modified alumina of Example 4 were incorporated inside the impregnator's pan and rotated at 30 rpm. The first portion of the mixed metal solution was added to the dispenser and flowed at a rate of 10 mL/min under the air nozzle. After the solution was added, the impregnated spheres were allowed to rotate for 10 minutes at 30 rpm; after this time, hot air was introduced in the pan chamber for 10 minutes. The impregnated spheres were transferred to stainless steel trays and place in the oven to dry them at 100° C. for 3 hours and then calcine them at 400° C. for 12 hours with a ramp of 5° C./min producing in this way Example 9 1^{st}-layer. After the spheres were calcined, they were placed back into the impregnator's pan to carry out the second impregnation with the second portion of the solution using the same protocol of the first impregnation. After the calcination, producing in this way Example 9 2^{nd}-layer, the produced material was again placed inside the impregnator's pan and its impregnation was carried out in the same fashion with the last portion of the solution producing in this way Example 2 3^{rd}-layer. Table 5 shows the average crystalline domain sizes measured by XRD as well as its textural properties, respectively.

### Example 10: Activation of the Catalyst of Example 9 for Steam Reforming

The activation of the catalysts of Example 9 was carried out in the same fashion as those of Example 3. Table 5 shows the average crystalline domain sizes measured by XRD as well as its textural properties, respectively. In this case, the final catalyst composition comprises: CeO₂, MnO and MgO. That is, the non-noble transition metal is manganese, the alkaline earth metal is magnesium, and the rare earth metal is Cerium.

The mass proportions of the components in these three catalysts are:
1^{st}-layer: % Al₂O₃=81.7; % CeO₂=13.3; % MnO=2.0 and % MgO=3.0 with a Mn/Ce atomic ratio of 0.38; a Mg/Mn atomic ratio of 2.5 and a Mg/Ce atomic ratio of 0.95.
2^{nd}-layer: % Al₂O₃=76.2; % CeO₂=14.4; % MnO=3.9 and % MgO=5.5 with a Mn/Ce atomic ratio of 0.65; a Mg/Mn atomic ratio of 2.5 and a Mg/Ce atomic ratio of 1.65.
3^{rd}-layer: % Al₂O₃=71.5; % CeO₂=15.3; % MnO=5.4 and % MgO=7.8 with a Mn/Ce atomic ratio of 0.86; a Mg/Mn atomic ratio of 2.5 and a Mg/Ce atomic ratio of 2.2.

TABLE 5
XRD average crystalline domain sizes and textural properties
of the produced materials of Examples 9 and 10.

| | XRD average crystalline | | | | | | External | BJH Pore | |
|---|---|---|---|---|---|---|---|---|---|
| | domain sizes [nm] | | | | BET area | Micro area | area | volume | BJH Pore |
| Sample | CeO₂ | MnO | MgO | Mn | [m²/g] | [m²/g] | [m²/g] | [cm³/g] | size [nm] |
| Example 9 | 8.8 | 7.0 | 3.8 | — | 120.2 | 6.3 | 113.9 | 0.3265 | 7.98 |
| (1^{st}-layer) | | | | | | | | | |
| Example 9 | 8.1 | 6.3 | 4.7 | — | 123.9 | 6.5 | 117.4 | 0.3287 | 7.76 |
| (2^{nd}-layer) | | | | | | | | | |
| Example 9 | 8.3 | 4.7 | 5.9 | — | 98.2 | 3.5 | 94.7 | 0.2493 | 7.10 |
| (3^{rd}-layer) | | | | | | | | | |
| Example 10 | 8.5 | — | 3.4 | 5.7 | 119.2 | — | 119.2 | 0.3541 | 8.05 |
| (1^{st}-layer) | | | | | | | | | |
| Example 10 | 8.1 | 6.2 | 4.8 | 5.3 | 101.8 | 11.1 | 90.7 | 0.2868 | 7.54 |
| (2^{nd}-layer) | | | | | | | | | |
| Example 10 | 8.4 | 5.4 | 5.3 | 5.4 | 95.6 | 9.6 | 86.0 | 0.2706 | 7.54 |
| (3^{rd}-layer) | | | | | | | | | |

### Example 11: Incorporation of FeO, MgO and CeO₂ on the CeO₂-Modified Alumina of Example 4

A solution of iron (II) nitrate was prepared by dissolving iron (II) sulfate in deionized water and adding a solution of calcium nitrate under agitation. A calcium sulfate precipitate was formed, and a green solution of iron (II) nitrate was obtained. The mixture was filtrated to remove the precipitated calcium sulfate and to obtain the iron (II) nitrate solution for further use. To prepare this Iron (II) nitrate solution 13.233 grams of iron (II) sulfate and 11.250 grams of calcium nitrate were used. To this iron (II) nitrate solution, magnesium nitrate and cerium nitrate were added by dissolving 8.598 grams of cerium nitrate and 30.516 grams of magnesium nitrate. The obtained solution was divided in three portions to be added by three successive impregnations as follows:

50 grams of the produced CeO₂-modified alumina of Example 4 were incorporated inside the impregnator's pan and rotated at 30 rpm. The first portion of the mixed metal solution was added to the dispenser and flowed at a rate of 10 mL/min under the air nozzle. After the solution was added, the impregnated spheres were allowed to rotate for 10 minutes at 30 rpm; after this time, hot air was introduced in the pan chamber for 10 minutes. The impregnated spheres were transferred to stainless steel trays and place in the oven to dry them at 100° C. for 3 hours and then calcine them at 400° C. for 12 hours with a ramp of 5° C./min producing in this way Example 11 1^{st}-layer. After the spheres were calcined, they were placed back into the impregnator's pan to carry out the second impregnation with the second portion of the solution using the same protocol of the first impregnation. After the calcination, producing in this way Example 11 2^{nd}-layer, the produced material was again placed inside the impregnator's pan and its impregnation was carried out in the same fashion with the last portion of the solution producing in this way Example 11 3^{rd}-layer. Table 6 shows the average crystalline domain sizes measured by XRD as well as its textural properties, respectively.

### Example 12: Activation of the Catalyst of Example 11 for Steam Reforming

The activation of the catalysts of Example 11 was carried out in the same fashion as those of Example 3. Table 6 shows the average crystalline domain sizes measured by XRD as well as its textural properties, respectively. In this case, the final catalyst composition comprises: CeO₂, FeO and MgO. That is, the non-noble transition metal is iron, the alkaline earth metal is magnesium, and the rare earth metal is Cerium.

The mass proportions of the components in these three catalysts are:
1^{st}-layer: % Al₂O₃=81.6; % CeO₂=13.3; % FeO=2.1 and % MgO=3.0 with a Fe/Ce atomic ratio of 0.38; a Mg/Fe atomic ratio of 2.5 and a Mg/Ce atomic ratio of 0.95.
2^{nd}-layer: % Al₂O₃=76.2; % CeO₂=14.4; % FeO=3.9 and % MgO=5.5 with a Fe/Ce atomic ratio of 0.65; a Mg/Fe atomic ratio of 2.5 and a Mg/Ce atomic ratio of 1.65.
3^{rd}-layer: % Al₂O₃=71.4; % CeO₂=15.3; % FeO=5.5 and % MgO=7.8 with a Fe/Ce atomic ratio of 0.87; a Mg/Fe atomic ratio of 2.5 and a Mg/Ce atomic ratio of 2.2.

TABLE 6
XRD average crystalline domain sizes and textural properties
of the produced materials of Examples 11 and 12.

| | XRD average crystalline | | | | | | External | BJH Pore | |
|---|---|---|---|---|---|---|---|---|---|
| | domain sizes [nm] | | | | BET area | Micro area | area | volume | BJH Pore |
| Sample | CeO₂ | Fe₂O₃ | MgO | Fe₃O₄ | [m²/g] | [m²/g] | [m²/g] | [cm³/g] | size [nm] |
| Example 11 | 8.2 | 4.4 | 3.6 | — | 140.3 | 8.4 | 131.9 | 0.3738 | 7.41 |
| (1^{st}-layer) | | | | | | | | | |
| Example 11 | 7.8 | 5.4 | 5.0 | — | 106.8 | 6.5 | 100.3 | 0.2994 | 7.77 |
| (2^{nd}-layer) | | | | | | | | | |
| Example 11 | 7.8 | 5.7 | 3.3 | — | 80.5 | 4.9 | 75.6 | 0.2074 | 7.23 |
| (3^{rd}-layer) | | | | | | | | | |
| Example 12 | 8.5 | — | 4.1 | 3.5 | 115.0 | 7.3 | 107.7 | 0.3293 | 7.71 |
| (1^{st}-layer) | | | | | | | | | |
| Example 12 | 8.4 | — | 4.1 | 3.1 | 121.6 | 10.4 | 111.2 | 0.3616 | 7.97 |
| (2^{nd}-layer) | | | | | | | | | |
| Example 12 | 8.6 | — | 4.9 | 5.4 | 101.1 | 4.0 | 97.1 | 0.2842 | 7.34 |
| (3^{rd}-layer) | | | | | | | | | |

### Example 13: Incorporation of CuO, CaO, La₂O₃ and CeO₂ on the CeO₂-Modified Alumina of Example 4

A solution of copper nitrate, calcium nitrate and lanthanum nitrate was prepared by dissolving 11.049 grams of copper nitrate, 8.661 grams of lanthanum nitrate and 28.448 grams of calcium nitrate in 47.7 mL of deionized water. The obtained solution was divided in three portions to be added by three successive impregnations as follows:

50 grams of the produced CeO₂-modified alumina of Example 4 were incorporated inside the impregnator's pan and rotated at 30 rpm. The first portion of the mixed metal solution was added to the dispenser and flowed at a rate of 10 mL/min under the air nozzle. After the solution was added, the impregnated spheres were allowed to rotate for 10 minutes at 30 rpm; after this time, hot air was introduced in the pan chamber for 10 minutes. The impregnated spheres were transferred to stainless steel trays and place in the oven to dry them at 100° C. for 3 hours and then calcine them at 400° C. for 12 hours with a ramp of 5° C./min producing in this way Example 13 1^{st}-layer. After the spheres were calcined, they were placed back into the impregnator's pan to carry out the second impregnation with the second portion of the solution using the same protocol of the first impregnation. After the calcination, producing in this way Example 13 2^{nd}-laye, the produced material was again placed inside the impregnator's pan and its impregnation was carried out in the same fashion with the last portion of the solution producing in this way Example 13 3^{rd}-layer. Table 7 shows the average crystalline domain sizes measured by XRD as well as its textural properties, respectively.

### Example 14: Activation of the Catalyst of Example 13 for Steam Reforming

The activation of the catalysts of Example 13 was carried out in the same fashion as those of Example 3. Table 7 shows the average crystalline domain sizes measured by XRD as well as its textural properties, respectively. In this case, the final catalyst composition comprises: CeO₂, CuO, CaO and La₂O₃. That is, the non-noble transition metal is copper, the alkaline earth metal is calcium, and the rare earth metals are Cerium and Lanthanum.

The mass proportions of the components in these three catalysts are:
1^{st}-layer: % Al₂O₃=80.6; % CeO₂=11.0; % CuO=2.3, % CaO=4.1 and % La₂O₃=2.0 with a Cu/Ce atomic ratio of 0.45; a Ca/Cu atomic ratio of 2.5 and a Ca/Ce atomic ratio of 1.14, Cu/La atomic ratio of 2.4; Ca/La atomic ratio of 6.0, Ce/La atomic ratio of 5.3.
2^{nd}-layer: % Al₂O₃=74.4; % CeO₂=10.2; % CuO=4.2, % CaO=7.6 and % La₂O₃=3.6 with a Cu/Ce atomic ratio of 0.90; a Ca/Cu atomic ratio of 2.5 and a Ca/Ce atomic ratio of 2.3, Cu/La atomic ratio of 2.4; Ca/La atomic ratio of 6.0, Ce/La atomic ratio of 2.6.
3^{rd}-layer: % Al₂O₃=69.1; % CeO₂=9.4; % CuO=5.9, % CaO=10.5 and % La₂O₃=5.1 with a Cu/Ce atomic ratio of 1.35; a Ca/Cu atomic ratio of 2.5 and a Ca/Ce atomic ratio of 3.4, Cu/La atomic ratio of 2.4; Ca/La atomic ratio of 6.0, Ce/La atomic ratio of 1.8.

TABLE 7
XRD average crystalline domain sizes and textural properties
of the produced materials of Examples 13 and 14.

| | XRD average crystalline | | | | | | | External | BJH Pore | |
|---|---|---|---|---|---|---|---|---|---|---|
| | domain sizes [nm] | | | | | BET area | Micro area | area | volume | BJH Pore |
| Sample | CeO₂ | CuO | CaO | La₂O₃ | Cu | [m²/g] | [m²/g] | [m²/g] | [cm³/g] | size [nm] |
| Example 13 | 8.5 | 3.9 | 3.8 | 5.4 | — | 89.4 | 11.0 | 78.4 | 0.2389 | 7.12 |
| (1^{st}-layer) | | | | | | | | | | |
| Example 13 | 8.7 | 5.3 | 5.6 | 6.5 | — | 99.0 | 12.0 | 87.0 | 0.3084 | 7.86 |
| (2^{nd}-layer) | | | | | | | | | | |
| Example 13 | 8.5 | 23.0 | 5.8 | 6.5 | — | 69.6 | 8.2 | 61.4 | 0.2020 | 7.29 |
| (3^{rd}-layer) | | | | | | | | | | |
| Example 14 | 8.5 | — | 4.2 | 5.7 | 5.5 | 109.1 | 12.0 | 97.1 | 0.3427 | 8.09 |
| (1^{st}-layer) | | | | | | | | | | |
| Example 14 | 8.6 | — | 6.2 | 6.6 | 17.9 | 90.1 | 10.4 | 79.7 | 0.2810 | 7.72 |
| (2^{nd}-layer) | | | | | | | | | | |
| Example 14 | 8.8 | — | 6.8 | 6.1 | 17.3 | 71.2 | 7.9 | 63.3 | 0.2397 | 7.98 |
| (3^{rd}-layer) | | | | | | | | | | |

### Steam Reforming of Light Hydrocarbons Using the Catalyst of Example 3

After finalizing the catalyst activation protocol, H₂@100 mL/min is changed to feedstock volumetric flow (12.9 mL/min) and the system pressure is adjusted to 30 Psig in preparation to the start-up of the catalytic test. Then, the feedstock (C1-3 blend) is allowed to enter the system with its respective water flow (Steam/C=5), after 3 minutes the H₂ flow is stopped and a 3-hour period is provided to confirm steady state and flush out any residual reducing gas before GC sampling began. The steam/C ratios are based on the number steam water molecules divided by the number of carbon atoms. That is, the steam/C ration is based on all the carbon atoms in the feedstock. The C from methane is 1, the C from ethane is 2 and the C from propane is 3; thus, in one mole of methane we have one mole of carbon; in a mole of ethane we have 2 moles of carbon and in a mole of propane we have 3 moles of carbon then, the amount of steam is divided by the moles of carbon on each molecule of the feedstock (and its given proportion on it) given a value of 5.

For this experiment, the temperature was maintained at 500° C.

To stop the reaction, the following protocol should be followed:

From reaction temperature, reactor is cooled (e.g., down to 200° C. or below with a ramp of at most 10° C./min) while maintaining reaction feedstock volumetric flow rates (i.e. blend of C1-3 and water). After this temperature is reached, the feedstocks can be stopped (by closing their respective valves and MFC) and the gases are changed to N₂ (or other inert gas at e.g., 30 mL/min) until reaching ambient temperature. Finally, catalyst may be maintained in an inert gas atmosphere, or the unit should be shut down (closing N₂ supply).

### Catalyst Reactivity Analysis

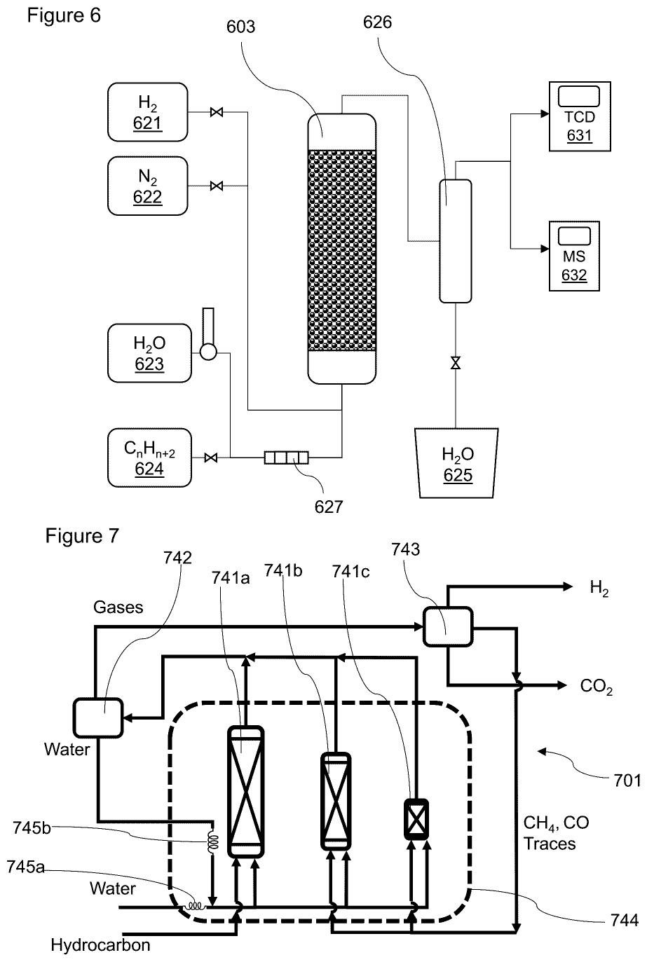

To determine the effectiveness of the catalyst, the reactivity was evaluated in the methane steam reforming reaction which is carried out at 30 psig in a fixed catalytic bed steam reforming reactor 603. The diagram of the experimental setup is illustrated in FIG. 6.

The experimental apparatus consists of several components.

The inlet section is configured to feed chemicals into the steam reforming reactor 603 from four sources: a hydrogen source 621, a nitrogen source 622, a hydrocarbon feedstock source 624 and a water source 623. The flow rates of the inlet gases (hydrogen, nitrogen and hydrocarbon blend) are set by three mass flow controllers. The flow rate of steam was controlled through an ISCO™ Model 500D syringe pump, where water is evaporated through a heating tape around a ⅜-inch SS tubing filled with glass beads (steam generator). It will be appreciated that the hydrogen and nitrogen sources may be used when the steam reforming reactor is not in active operation. For example, the hydrogen source may be used when activating the catalyst, and the nitrogen may be used when shutting down the reactor after use.

The reaction mixture of the hydrocarbon blend and H₂O vapor are premixed in a pre-heater section 627 before introducing them into the reactor at a proper H₂O/CH₄ molar ratio.

The reaction section consists of a catalytic fixed bed reactor 603 having an up-flow configuration where reactants are feed into the bottom of the reactor and products and unreacted reactants are extracted at the top. In this embodiment, the reactor is heated using heating tapes and the reaction temperature is measured by a multi sensors thermocouple placed at the level of the catalyst. At the outlet of the reactor, a cold trap 626 is used to condense water from the product gas stream which is collected in vessel 625.

For analysis, the dry outlet gaseous products (H₂, CO, CO₂, non-reacted CH₄ and higher hydrocarbons) are analyzed and quantified by an online gas chromatograph 631 equipped with two thermal conductivity detectors (TCD) and a quadrupole mass spectrometer 632.

Table 8 shows two examples of feedstock tested in LTMSR at a specific set of reaction conditions. Table 9 shows results obtained using the experimental apparatus described above.

TABLE 8
Molar Composition of a Typical Natural Gas (Feedstock 1) and a
blend of gases typically produced in a refinery (Feedstock 2)

| | Feedstock #1 | Feedstock #2 |
|---|---|---|
| Feedstock | (Typical Natural Gas | (Typical Gases from |
| Component | Composition) | Refinery) |
| N₂ | 0.9 | — |
| CH₄ | 93.2 | 81.0 |
| C₂H₆ | 5.7 | 9.5 |
| C₃H₈ | 0.2 | 5.7 |
| C₄H₁₀ | — | 3.8 |

TABLE 9
a summary of the experimental results obtained in LTMSR with the two
feedstocks presented in Table 8 using the catalyst formulation of Example
2 with 3 layers of active phase at 500° C., gas hourly space velocity,
GHSV (referred to CH₄-i.e. It is the gas hourly space velocity defined
as: CH₄ Gas Flow Rate/Reactor Volume) = 1300 h⁻¹, P = 30 psig and
Steam-to-C molar ratio = 14.

| | Feedstock #1 | Feedstock #2 |
|---|---|---|
| Equilibrium CH₄ Conversion* | 99.8 | 98.8 |
| CH₄ Conversion [mole %] | 90 | 83 |
| C₂H₆ Conversion [mole %] | 100 | 100 |
| C₃H₈ Conversion [mole %] | 100 | 100 |
| C₄H₁₀ Conversion [mole %] | N/A | 100 |
| Feedstock Gas Flow Rate | 80 | 92 |
| [mL/min] | | |
| Average Gas Product Flow Rate | 324 | 435 |
| [mL/min] | | |
| Composition of the Gases at the | | |
| outlet [mole %] | | |
| N₂ | 0.1 | Not Applicable |
| CH₄ | 1.9 | 3.0 |
| H₂ | 73.6 | 71.1 |
| CO | 1.6 | 1.8 |
| CO₂ | 22.7 | 24.1 |
| Average Experimental CO₂/CH₄ | 11.0 | 8.2 |
| Ratio | | |
| Theoretical CO₂/CH₄ Ratio | 10.3 | 7.8 |
| Experimental H₂/CO₂ Ratio | 3.3 | 3.1 |
| Theoretical H₂/CO₂ Ratio | 3.9 | 3.7 |
| Carbon Mass Balance Closure | 101.2 | 103.5 |
| [%] | | |
| H₂ Production [mL/min] | 238 | 309 |
| CO₂ Production [mL/min] | 74 | 105 |

The Equilibrium calculations were carried out with the Cantera software as implemented in the BIOVIA Materials Studio 2020 package from Dassaul Systemes ™

The carbon mass balance closure relates the mols of C entering and leaving a system. Closing atomic mass balances is a critical and necessary step for verifying the performance of any conversion process.

The Theoretical CO₂/CH₄ and H₂/CO₂ molar ratios presented in the table above have been obtained considering the compositions of the reaction gases (Feedstock #1and Feedstock #2) and assuming no side reactions, thus 100% selectivity toward direct steam reforming products.

The results shown in Table 9 indicate that the catalyst can achieve near-equilibrium conversion rates (90%) at very mild reaction temperature (i.e.: 500° C.) using a space velocity similar to the values traditionally used in the industry.

The experimental CO₂/unreacted-CH₄ and H₂/CO₂ molar ratios obtained for both feedstocks are slightly higher from what has been calculated theoretically. The difference in values seems to indicate a slightly higher CO₂ production. This could indicate the presence of one or more side reactions.

By adjusting the reaction conditions to a lower severity, preferably by increasing the space velocity, which increases hydrogen productivity, the CO₂/unreacted-CH₄ is reduced to the target molar ratio of 1 that allows producing green hydrogen and the required molar proportion of the mixture CO₂-CH₄ to produce carbon nanofibers according to previous art (WO 2020/154799 A1).

### Further Experiments

In the experiments detailed in the sections that follow, four catalytic formulations were evaluated at different space velocities to assess their performance. Additionally, all experiments were conducted using a lower steam/C molar ratio (S/C) of 5, which is a standard value commonly used in commercial steam reforming operations. The reason behind this choice is that, while using an excessive amount of steam beyond the stoichiometric ratio can reduce the risk of thermal cracking of hydrocarbons and coke formation, it also results in substantial operational expenses. Similar to Test #1 and #2, all tests were conducted at a reaction temperature of 500° C., pressure of 30 psig and utilizing Feedstock #1.

Table #10 shows the results that were obtained using the catalyst formulation of Example 2 with 3 layers of active phase at different GHSV.

TABLE 10
(Test #3): Summary of the experimental results obtained with the
catalyst of Example 2 with 3 layers of active phase:

| GHSV (h⁻¹) | 1300 | 3000 | 5000 | 6500 | 8000 |
|---|---|---|---|---|---|
| Equilibrium CH₄ | 93.5 | 93.5 | 93.5 | 93.5 | 93.5 |
| Conversion* | | | | | |
| CH₄ Conversion [mole %] | 63 | 46 | 44 | 33 | 33.0 |
| C₂H₆ Conversion [mole %] | 100 | 100 | 98.2 | 79 | 55.7 |
| C₃H₈ Conversion [mole %] | 100 | 100 | 100 | 100 | 62.3 |
| Feedstock Gas Flow Rate | 62.3 | 143.8 | 239.7 | 311.6 | 383.5 |
| [mL/min] at STP | | | | | |
| Experimental Average Gas | 237.6 | 463.2 | 743.16 | 813.7 | 955.8 |
| Product Flow Rate [mL/ | | | | | |
| min] at STP | | | | | |
| Vol Flow Rate Ratio- | 3.8 | 3.2 | 3.1 | 2.6 | 2.5 |
| Product/Feed | | | | | |
| Experimental Unreacted | ND | 0.493 | ND | 1.155 | 1.44 |
| Water (g/min) | | | | | |

Composition of the Gases at the outlet [mole %]

| | | | | | |
|---|---|---|---|---|---|
| N₂ | 0.23 | 0.28 | 0.29 | 0.34 | 0.36 |
| CH₄ | 8.93 | 15.68 | 16.71 | 23.87 | 24.96 |
| H₂ | 71.71 | 66.47 | 65.69 | 59.84 | 58.55 |
| CO | 0.80 | 0.48 | 0.38 | 0.06 | 0.10 |
| CO₂ | 18.32 | 17.09 | 16.90 | 15.43 | 14.98 |
| Ethane | 0.00 | 0.00 | 0.03 | 0.46 | 1.01 |
| Propane | 0.00 | 0.00 | 0.00 | 0.00 | 0.03 |
| CO₂/CH₄ Ratio | 2.05 | 1.09 | 1.01 | 0.65 | 0.60 |
| H₂/CO₂ Ratio | 3.91 | 3.89 | 3.89 | 3.88 | 3.91 |

*The Equilibrium calculations were carried out with the Cantera software as implemented in the BIOVIA Materials Studio 2020 package from Dassault Systemes.

At a space velocity of 1300 h⁻¹, a decrease in the steam to carbon ratio from 14 to 5 resulted in a significant drop in the methane conversion rate, from 90% to 63%. This reduction in conversion can be attributed to the limited availability of steam, which slows down the reaction rate and reduces the process efficiency.

Despite activity reductions at a steam to carbon (S/C) ratio of 5, the methane conversions obtained at space velocities up to 5000 h⁻¹ are still higher than the conversion rate required to achieve a CO₂/unreacted CH₄ ratio at the reactor outlet that is close to the stoichiometric feed ratio needed for dry methane reforming. As previously mentioned in this document, the required methane conversion rate for this specific feedstock with a typical natural gas composition is 40% and the catalyst is capable of achieving the desired conversion rate up to a space velocity of 5000 h⁻¹, indicating that the system is effective at converting methane.

Additionally, the results demonstrate highly acceptable levels of methane conversion even at significantly increased space velocities of up to 8000 h⁻¹.

The results also indicated that propane was fully converted at a space velocity of up to 6500 h⁻¹, and ethane was fully converted at a space velocity of up to 5000 h⁻¹, showcasing the high effectiveness of the current catalyst formulation in performing efficiently under a wide range of reaction conditions.

The selectivity of the process towards direct steam reforming was further confirmed by the results shown in Table #10, which demonstrate full suppression of alternative reactions and nearly 100% selectivity towards direct steam reforming. The low CO production, recorded at a level below 1 mol %, is a remarkable advantage. This outcome can be attributed to the unique properties of the catalyst, which allows for operation at temperatures lower than those commonly used in commercial applications. This reduction in temperature effectively suppresses reverse water-gas shift reactions, reducing the formation of hazardous by-products like CO.

The carbon balance of the process was also found to be highly satisfactory, with a deviation of approximately 3% in all cases studied.

Table #11 shows the results that were obtained using the catalyst formulation of Example 2 with 2 layers of active phase, at different GHSV.

TABLE #11
(Test #4): Summary of the experimental results obtained
with the catalyst of Example 2 with 2 layers of active phase.

| | | | | | | |
|---|---|---|---|---|---|---|
| GHSV (h⁻¹) | 250 | 1300 | 3000 | 4000 | 5000 | 6500 |
| Equilibrium CH₄ | 93.5 | 93.5 | 93.5 | 93.5 | 93.5 | 93.5 |
| Conversion* | | | | | | |
| CH₄ Conversion [mole %] | 72 | 58.5 | 58.0 | 57.0 | 54 | 50 |
| C₂H₆ Conversion [mole %] | 100 | 100 | 100 | 100.0 | 100 | 100 |
| C₃H₈ Conversion [mole %] | 100 | 100 | 100 | 100.0 | 100 | 100 |
| Feedstock Gas Flow | 12.8 | 66.4 | 153.3 | 204.4 | 255.4 | 332.1 |
| Rate [mL/min] at STP | | | | | | |
| Experimental Average | 52.7 | 242.0 | 558.3 | 736.0 | 887.2 | 1110.3 |
| Gas Product Flow Rate | | | | | | |
| [mL/min] at STP | | | | | | |
| Vol Flow Rate Ratio - | 4.1 | 3.6 | 3.6 | 3.6 | 3.5 | 3.3 |
| Product/Feed | | | | | | |
| Experimental Unreacted | 0.038 | 0.220 | 0.485 | Not | 0.841 | 1.145 |
| Water (g/min) | | | | Determined | | |

Composition of the Gases at the outlet [mole %]

| | | | | | | |
|---|---|---|---|---|---|---|
| N₂ | 0.22 | 0.25 | 0.24 | 0.25 | 0.03 | 0.27 |
| CH₄ | 6.24 | 10.48 | 10.64 | 11.12 | 12.21 | 13.84 |
| H₂ | 74.16 | 70.42 | 70.13 | 70.57 | 69.28 | 67.78 |
| CO | 0.48 | 0.85 | 1.04 | Below | 0.73 | 0.72 |
| | | | | Detection | | |
| | | | | Limits | | |
| CO₂ | 18.9 | 18.02 | 17.95 | 18.07 | 17.75 | 17.40 |
| CO₂/CH₄ Ratio | 3.03 | 1.72 | 1.69 | 1.63 | 1.45 | 1.26 |
| H₂/CO₂ Ratio | 3.9 | 3.9 | 3.9 | 3.9 | 3.9 | 3.9 |

The catalyst employed in this test exhibits a similar composition in terms of constituent species to that used in previous tests, however, it contains a lower proportion of active phases, Ni, Ce, and Mg, with a reduction of about ⅓ in their relative amounts.

This improved performance of the present catalyst is a result of its unique composition, which includes a lower proportion of active phases, Ni, Ce, and Mg, compared to the catalyst used in the previous example. The optimization of the active phase content enhances the catalyst's ability to perform efficiently under a wide range of space velocities. The results show that even with an increase in the space velocity, the conversion rate does not experience a significant drop, reaching 50% even at the highest space velocity of 6500 h⁻¹. Furthermore, the complete conversion of both ethane and propane in all tested space velocity ranges, with a maximum of 6500 h⁻¹, further supports the superiority of the present catalyst formulation. Lastly, the reduction in the proportion of active phases in the formulation offers a more cost-effective solution for the manufacturing process of the catalyst.

The carbon balance of the process was also found to be highly satisfactory, with a deviation of approximately 3%.

Table #12 shows the results that were obtained using the catalyst of Example 2 with 1 layer of active phase and different SV.

TABLE #12
(Test #5): Summary of the experimental results obtained with the
catalyst of Example 2 with 1 layer of active phase

| GHSV (h⁻¹) | 250 | 1300 | 3000 | 6500 |
|---|---|---|---|---|
| Equilibrium CH₄ | 93.5 | 93.5 | 93.5 | 93.5 |
| Conversion* | | | | |
| CH₄ Conversion | 69 | 58 | 51.0 | 29.5 |
| [mole %] | | | | |
| C₂H₆ Conversion | 100 | 100 | 100 | 61.2 |
| [mole %] | | | | |
| C₃H₈ Conversion | 100 | 100 | 100 | 100 |
| [mole %] | | | | |
| Feedstock Gas Flow | 13.0 | 67.6 | 156.0 | 337.9 |
| Rate [mL/min] at STP | | | | |
| Experimental Average | 52.4 | 246.7 | 528.1 | 811.3 |
| Gas Product Flow Rate | | | | |
| [mL/min] at STP | | | | |
| Vol Flow Rate Ratio- | 4.0 | 3.7 | 3.4 | 2.4 |
| Product/Feed | | | | |
| Experimental Unreacted | 0.040 | 0.226 | 0.512 | 1.261 |
| Water (g/min) | | | | |

Composition of the Gases at the outlet [mole %]

| | | | | |
|---|---|---|---|---|
| N₂ | 0.22 | 0.25 | 0.3 | 0.37 |
| CH₄ | 7.13 | 10.66 | 13.4 | 27.33 |
| H₂ | 73.82 | 70.27 | 68.1 | 56.72 |
| CO | Not | 0.85 | 0.8 | 0.07 |
| | Applicable | | | |
| CO₂ | 18.83 | 17.98 | 17.5 | 14.59 |
| Ethane | 0.00 | 0.00 | 0.0 | 0.92 |
| CO₂/CH₄ Ratio | 2.64 | 1.69 | 1.30 | 0.53 |
| H₂/CO₂ Ratio | 3.9 | 3.9 | 3.9 | 3.9 |

*The Equilibrium calculations were carried out with the Cantera software as implemented in the BIOVIA Materials Studio 2020 package from Dassault Systems

This alternative catalyst demonstrated potential in its performance, exhibiting a comparable level of methane conversion up to a space velocity of 3000 h−1, despite having a lower proportion of active phases in its composition. The decrease in the active phases, Ni, Ce, and Mg, resulted in a ⅔ reduction in their relative amounts, offering significant economic advantages in terms of catalyst production.

Despite the lack of testing within the range of 3000 h⁻¹ to 6500 h⁻¹, the available data suggests a decline in activity at higher space velocities. This is inferred from the observed conversion levels of methane and ethane at 6500 h⁻¹, which appear to be reduced. Nevertheless, the catalyst's low active phase concentration still makes it an attractive option for further study and development.

The carbon balance of the process was also found to be highly satisfactory, with a deviation of approximately 3%.

Table #13 shows the results that were obtained using the catalyst of Example 5 with 3 layers of active phase and a GHSV=250 h⁻¹.

TABLE #13
(Test #6): Summary of the experimental results obtained with the
catalyst of Example 5 with 3 layers of active phase

| GHSV (h⁻¹) | 250 |
|---|---|
| Equilibrium CH₄ Conversion* | 93.5 |
| CH₄ Conversion [mole %] | 17 |
| C₂H₆ Conversion [mole %] | 50 |
| C₃H₈ Conversion [mole %] | 80 |
| C₄H₁₀ Conversion [mole %] | NA |
| Feedstock Gas Flow Rate [mL/min] at STP | 12.0 |
| Experimental Average Gas Product Flow Rate | 22.7 |
| [mL/min] at STP | |
| Vol Flow Rate Ratio-Product/Feed | 1.9 |
| Experimental Unreacted Water (g/min) | 0.047 |

Composition of the Gases at the outlet [mole %]

| | |
|---|---|
| N₂ | 0.48 |
| CH₄ | 41.13 |
| H₂ | 45.15 |
| CO | NA |
| CO₂ | 11.71 |
| Ethane | 1.52 |
| Propane | 0.02 |
| CO₂/CH₄ Ratio | 0.28 |
| H₂/CO₂ Ratio | 3.86 |

*The Equilibrium calculations were carried out with the Cantera software as implemented in the BIOVIA Materials Studio 2020 package from Dassault Systemes.

In the final tested catalyst formulation, the active phases were similar in concentration to those found in the catalyst formulation of Example 2 with 3 layers, however, Nickel was replaced by Cobalt. The results of this single test, performed at a space velocity of 250 h⁻¹, showed lower conversion levels compared to previous tests. The low conversions rate may be attributed to the activation protocol not being optimized for this specific catalyst system.

Nevertheless, the conversion was still 100% attributed to direct steam reforming, as no secondary reactions were detected.

The carbon balance of the process was also found to be highly satisfactory, with a deviation of approximately 3%.

### Low Temperature Steam Reforming

To focus on the Low Temperature Steam Reforming aspect of the present disclosure, in another embodiment the Low Temperature Steam Reforming process may be used as a stand-alone process to control, increase and/or maximise the conversion of methane via several reaction chambers aligned in parallel and/or in series.

In Table 11, it can be seen that a conversion higher than 55% can be achieved with the catalyst described herein (but not exclusively with it) at space velocities as high as 4000 h⁻¹ and in a single pass through the reaction chamber. Reducing the temperature and simplifying of the conventional Steam Methane Reforming (SMR) process (e.g., by eliminating pre-reforming and water gas shift reactors of conventional SMR) means that increasing the amount of catalyst to match the same high productivity of conventional SMR may be feasible with the present technology.

That is, the catalyst modifications disclosed above to provide a high surface area and good stability enables a high level of conversion, even at lower temperatures. The low energy required to achieve a temperature range of around 500° C. (compared to conventional steam reforming at approximately 900° C.) allows using a conventional electric heating to significantly reduce the direct CO₂ footprint of the process. The lower temperatures used may allow the construction of the reactor to be simplified as the use of high temperature alloy for the hot zones can be reduced or eliminated.

Due to thermodynamic considerations, Low Temperature Steam Reforming is selectively directed towards H₂ and CO₂, which reduces or eliminates the requirement for a dedicated water-gas shift (WGS) reactor.

FIG. 7 is a schematic diagram of a Low Temperature Steam Reforming reactor 701. In this embodiment, the reactor comprises multiple reaction chambers, in which steam and hydrocarbons (e.g., including methane) are passed through to produce hydrogen and carbon dioxide. In this case, the multiple reaction chambers comprise a first reaction chamber 741a, a second reaction chamber 741b and a third reaction chamber 741c.

In this case, all of the multiple reaction chambers are housed within the same heat radiating zone (e.g., an electric oven 744) which heats the reaction chamber to the desired temperature (e.g., in the range 480-520° C.). The pressure within the reaction chambers is 3-10 bars (43-150 psi).

In this case, the first reaction chamber 741a receives the hydrocarbon feed from the source and water from a water feed.

In this embodiment, the outlets of each of the reaction chambers are connected to a water separator 742 for separating the water from the other gases exiting the reaction chambers. The water separator may comprise a condenser to condense the steam while the other gases remain in their gaseous state. The separated water may be recycled back to the inlets of the reaction chambers after being reconverted into steam by one or more steam generators 745b. In this case, the reactor comprises a separate feed steam generator 745a for generating steam from the water feed.

The other gases (including H₂, CO₂, CH₄) are then passed through a gas separator 743 configured to separate out each of the hydrogen and carbon dioxide products and the unreacted methane. The methane stream may comprise trace components of carbon monoxide.

Subsequent reaction chambers (i.e., second and third reaction chambers in this case) receive hydrocarbons from the recycled separated methane stream and steam from a combination of the water feed and the recycled water.

In this case, each subsequent reaction chamber is smaller than the last. This allows the Gas Hourly Space Velocity to be the same or similar for each of the reaction chambers (e.g., the GHSV of each reaction chamber within 20% of the mean average across all the reaction chambers within the heat radiating zone).

The steam/C molar ratio of each subsequent reaction chamber may be the same or higher than the last. In this case, the steam/C molar ratio for the first reaction chamber 741a is around 4, the steam/C molar ratio for the second reaction chamber 741b is around 10, and the steam/C molar ratio for the third reaction chamber 741b is around 15.

As described above, in this embodiment, the methane stream from the gas separator is recycled to the second and third reaction chambers. This is a simple configuration and can be controlled to provide a specific methane to carbon dioxide ratio (e.g., for dry reforming as described above).

In this case, the second reaction chamber is larger than the third reaction chamber and the system is configured to divide the separated methane stream between the second and third reaction chambers in a particular ratio.

In other embodiments, for example where the conversion of methane should be increased or maximized, each subsequent reaction chamber may receive methane from the outlet of the previous reaction chamber in the chain via a dedicated gas separator. For example, in a three-reactor-vessel system, a first gas separator would separate the unreacted methane received from the outlet of the first reaction chamber and deliver the separated methane to the inlet of the second reaction chamber. Then a second gas separator would separate the unreacted methane from the received from the outlet of the second reaction chamber and deliver the separated methane to the inlet of the third reaction chamber. Ensuring gas flow that travels more strictly in series may improve the overall conversion ratio.

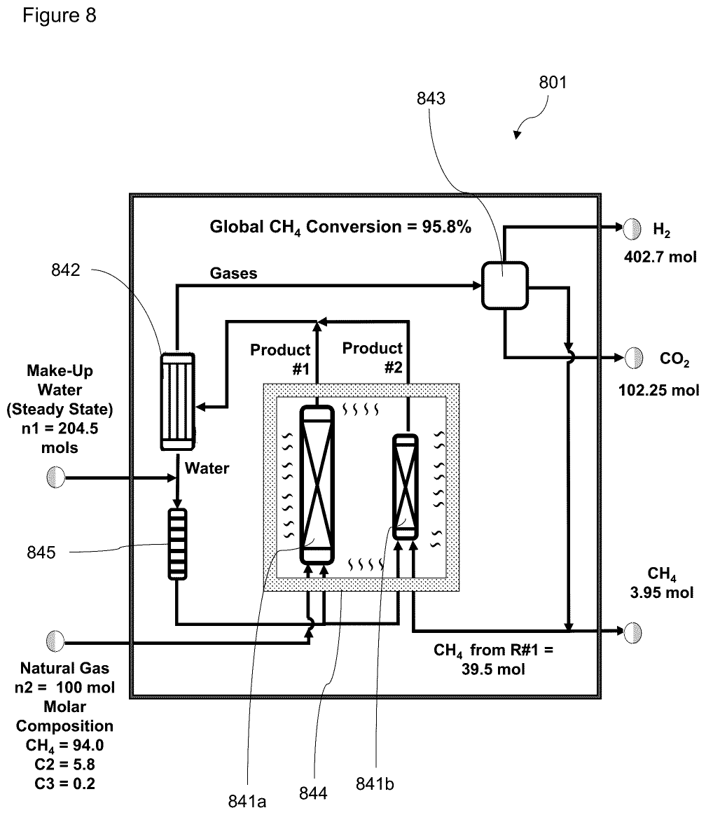

FIG. 8 is a schematic diagram of a Low Temperature Steam Reforming reactor 801 which was used to test experimentally the efficiency of methane conversion. FIG. 8 also shows the molar quantities of reactants and products at various points as they pass though the reactor. The molar quantities may also correspond to rates (e.g., mols/min).

As in the embodiment of FIG. 7, the reactor comprises multiple reaction chambers (in this case two reaction chambers instead of three), in which steam and hydrocarbons (e.g., including methane) are passed through to produce hydrogen and carbon dioxide. The reactors in this embodiment are a first reaction chamber 841a and a second reaction chamber 841b.

In this case, all of the multiple reaction chambers 841a,b are housed within the same heat radiating zone (in this case, an electric oven 844) which heats the reaction chambers to the desired temperature. Both reaction chambers 841a,b were operated at a reaction temperature of 500° C. and pressure of 30 psig. The catalyst in both reaction chambers is that described in Example 2 above (two layers of active sites) in both reactors.

In this case, the first reaction chamber inlet receives the hydrocarbon feed from the source. In this case, the hydrocarbon feed is natural gas (Feedstock #1). Subsequent reaction chamber inlets (i.e., the inlet of the second reaction chamber 841b in this case) receive hydrocarbons from the recycled separated methane stream. It was found that the first reactor converted 58% of the received methane (by molar amount), and the second reactor converted 90% of the received (recycled) methane (by molar amount).

In this case, the outlets of the reaction chambers have the following compositions:
Molar ratio of first reactor (Product #1): CH₄=39.5 mol, H₂=260.5 mol, CO₂=66.7 mol, and H₂O=397.5 mol.
Molar ratio of second reactor (Product #2): CH₄=3.95 mol, H₂=142.20 mol, CO₂=35.55 mol, and H₂O=481.89 mol.

These numbers indicate that the amount of methane exiting the second reaction chamber is one tenth of the methane exiting the first reaction chamber.

The outlets of each of the reaction chambers are connected to a water separator 842 for separating the water from the other gases. The water separator may comprise a condenser to condense the steam. The separated water may be recycled back to the inlets of the reaction chambers after being reconverted into steam by one or more steam generators 845.

The other gases are then passed through a gas separator 843 configured to separate out each of the hydrogen and carbon dioxide products and the unreacted methane. The methane stream may comprise trace components of carbon monoxide.

The first reactor was operated at a GHSV of 4000 h⁻¹ and an S/C molar ratio of 5, leading to a conversion of 58%. The second reactor, which receives the remaining unreacted methane from the first reactor, was run at the same space velocity but with a higher S/C molar ratio of 14, resulting in a methane conversion of 90%. The overall molar methane conversion is over 95% (95.8% in this case).

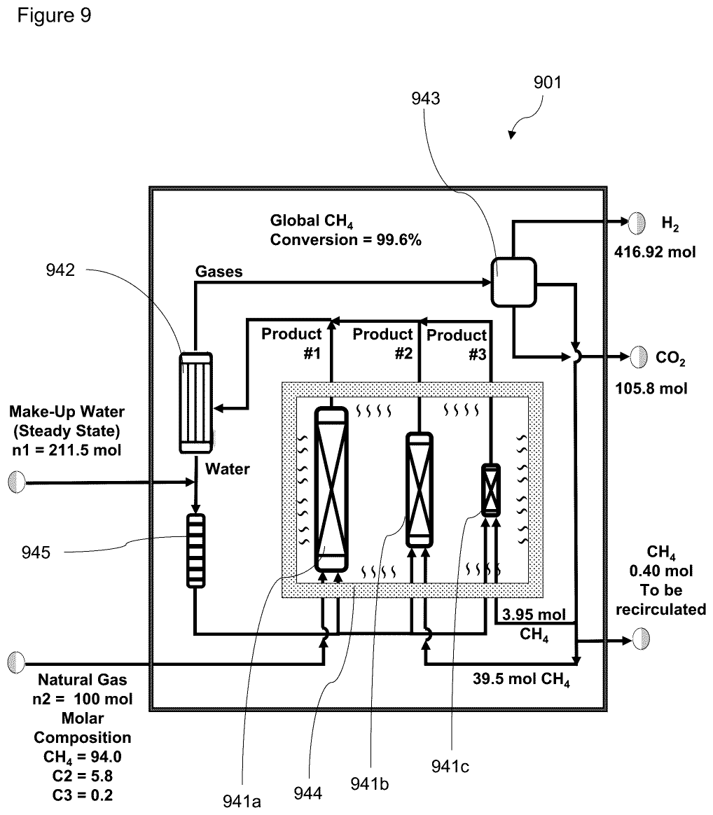

FIG. 9 is a schematic diagram of a Low Temperature Steam Reforming reactor 901 which was used to test the efficiency of methane conversion using a mathematical simulation. Compared with the experimental set up depicted in FIG. 8, the embodiment of FIG. 9 includes an additional third reactor in series to further convert unreacted methane from the second reactor. That is, this system comprises a first reaction chamber 941a, a second reaction chamber 941b and a third reaction chamber 941c. FIG. 9 also shows the molar quantities of reactants and products at various points as they pass though the reactor. The molar quantities may also correspond to rates (e.g., mols/min).

The third reaction chamber 941c was also operated under the same conditions as the second. With an initial natural gas inlet rate of 100 mol/min provided to the first reaction chamber and a GHSV of 4000 h⁻¹ for all three reaction chambers, the weight of catalyst used in reactor 1, 2, and 3 was 33.4, 14.0, and 1.4 kg, respectively, indicating a significant reduction in reaction chamber size while progressively converting methane until reaching near-extinction levels. Regarding the molar steam to carbon ratio, the first reaction chamber had a S/C ratio of 5, the second reaction chamber had a steam/C ratio of 14, and the third reactor had a S/C ratio of 14.

As in the embodiment of FIG. 7, each of the outlets of the three reaction chambers are directed to a water separator 942 which separates the water from the other gases present. This water is recycled back to the reaction chamber inlets via a steam generator 945. Additional water required for the reactions is provided from a make-up water stream.

The remaining gases are directed to a gas separator 943 which separates the gases into hydrogen, carbon dioxide and methane streams. The methane stream may contain trace quantities of carbon monoxide. The methane stream is recycled to the inlets of the second and third reaction chambers 841b, 841c.

In this case, the second reaction chamber is larger than the third reaction chamber and the system is configured to divide the separated methane stream between the second and third reaction chambers in a particular ratio. In this case, the ratio is such that the second reactor receives the same quantity of unreacted methane exiting from the first reaction chamber, and the third reaction chamber receives the amount of methane that would be exiting the second reaction chamber if the second and third reaction chamber were arranged in series with a dedicated separator positioned between the second and third reaction chambers. In this case, that corresponds to 39.5 mol of methane going to reaction chamber 2, and 3.95 mol going to reaction chamber 3. Dividing the separated methane in this way between the second and third reaction chambers helps maximize the overall conversion of methane without the need for a dedicated additional separator between the second and third reactor chambers. It will be appreciated that in embodiments with even more reaction chambers, the separated methane may be separated between the reaction chambers in an analogous way to increase overall methane conversion. For example, in steady state operation, the system may be configured and/or controlled such that each subsequent reactor vessel receives a quantity of methane equivalent to the amount of methane emitted by another reaction vessel. E.g., a second reactor may receive the same amount of methane as is emitted by the first, a third reactor may receive the same amount of methane as is emitted by the second, a fourth reactor may receive the same amount of methane as is emitted by the third and so on.

In this embodiment, the S/C ratio for the second and third reaction chambers is the same. In other embodiments, the S/C ratio of each reaction vessel can be adjusted by changing the quantity of hydrocarbon and/or steam supplied to the inlet or inlets of each reaction chamber.

In this configuration, the outlets of the reaction chambers were determined to have the following compositions:
Molar ratio of first reactor (Product #1): CH₄=39.5 mol, H₂=260.5 mol, CO₂=66.7 mol, and H₂O=397.5 mol
Molar ratio of second reactor (Product #2): CH₄=3.95 mol, H₂=142.20 mol, CO₂=35.55 mol, and H₂O=481.89 mol.
Molar ratio of third reactor (Product #3): CH₄=0.40 mol, H₂=14.22 mol, CO₂=3.55 mol, and H₂O=48.19 mol.

The results demonstrate that by combining the three reactors, a global methane conversion greater than 99% can be achieved (99.6% in this simulation).

As described above, this Low Temperature Steam Reforming reactor can be used to increase or maximise the conversion of methane. In other configurations, these reactors (or reactors with a single reaction chamber) can be configured to reduce the conversion of methane such that a proportion of the methane can pass through the reactor in an unreacted state. The reaction may be controlled such that the number ratio between the produced carbon dioxide to the unreacted methane exiting the reactor is between 0.9 and 1.1.

The reactor may be combined with a dry reforming of methane (DRM) reactor to produce an output of syngas where the number ratio between carbon monoxide and hydrogen is around 1 (e.g., between 0.9 and 1.1).

This proportion may be adjusted with available hydrogen from the steam reforming to produce the desired proportion to manufacture products such as graphite, carbon nanofiber, methanol or any other one carbon block petrochemical such as formic acid or formaldehyde. Longer chain carbon hydrocarbons may also be produced using the syngas.

### Other Considerations

The support where the active metal (or metals) is incorporated plays an important role on the dispersion by providing a high surface area but also can provide some properties like basicity, oxygen storage and reducibility which can have implications for their resistance against carbon formation.

Promoters are also implemented to develop a reforming catalyst and there are two main types of promoters; one is responsible for modifying the textural or structural properties and the other one modifies the chemical or electronic properties. To avoid completely, or at least to delay for some long time the sintering of the active species, textural promoters are typically employed to enhance the textural properties of the catalyst. On the other hand, chemical promoters help to moderate the formation of carbon and oxidize carbonaceous species by providing additional new active sites or enhancing the chemical property relating to the reactivity of the catalyst by modifying the basicity or redox properties in general.

Suitable preparation methods as well as activation protocols must be designed and developed as the employed preparation and activation methods strongly influence the physicochemical and catalytic performance of the reforming catalyst. Thus, suitable and proper preparation methods are able to produce better dispersion of the active phases, gives stronger metal-support interaction and high surface areas. All of these are responsible for the desired high activity, stability and resistance against sintering and carbon formation. An optimized preparation method can strengthen the distinct ability of the support. The activation protocol, to make the catalyst active for reforming, has a significant role in the formation of the active species and how the atoms organize themselves, thereby influencing the catalytic performance. It is well-known that a “bad activation” is responsible for the unsuccessful performance of a very promising catalyst.

Although the present present disclosure has been described and illustrated with respect to preferred embodiments and preferred uses thereof, it is not to be so limited since modifications and changes can be made therein which are within the full, intended scope of the present disclosure as understood by those skilled in the art.

### BIBLIOGRAPHY

1. Robert Napier, Estimating the carbon footprint of hydrogen production. Forbes, Jun. 6, 2020. https://www.forbes.com/sites/rrapier/2020/06/06/estimating-the-carbon-footprint-of-hydrogen-production
2. Hydrogen and Fuel Cell Technologies Office; Hydrogen Production: Electrolysis. https://www.energy.gov/eere/fuelcells/hydrogen-production-electrolysis
3. James Vickers, David Paterson, Katie Randolph; Cost of Electrolytic Hydrogen Production with Existing Technology; DOE Hydrogen and Fuel Cells Program Record #20004, Sep. 14, 2020. https://www.hydrogen.energy.gov/pdfs/20004-cost-electrolytic-hydrogen-production.pdf
4. Paul O'Connor; “Process for the Production of Hydrogen”; U.S. Pat. No. 10,882,743 B2; Jan. 5, 2021.
5. Zhonghua John Zhu, Jiuling Chen, Gaoqing Max Lu, Gregory Solomon; “Method for producing a hydrogen enriched fuel and carbon nanotubes using microwave assisted methane decomposition on catalyst.”; U.S. Pat. No. 8,092,778 B2; Jan. 10, 2012.
6. Don Henley, Timothy J. Imholt; “Method and Apparatus for hydrogen production from greenhouse gas saturated carbon nanotubes and synthesis of carbon nanostructures therefrom”; U.S. Pat. No. 7,468,097 B2; Dec. 23, 2008.
7. Charlotte Vinding Ovesen; Christian Daugaard; Fernando Morales Cano; “Reforming catalyst”; International Publication Number; WO 2021/152116 A1; Aug. 5, 2021.
8. Ashish Dilip Shejale; “Steam reforming catalysts for sustainable hydrogen production from bio-based materials”; International Publication Number; WO 2020/230160 A1; Nov. 19, 2020.
9. Gaetano Laquaniello; Emma Palo; Vincenzo Palma, Antonio Ricca, Concetta Ruocco; “Catalyst for low temperature ethanol steam reforming and related process”; United States Patent Application Publication; US 2019/0127220 A1; May 2,2019.
10. Shizhong Zhao; Yeping Cai; Xiao D. Hu; Jon P. Wagner; Jurgen Ladebeck; R. Steve Spivey; “Promoted calcium-aluminate supported catalysts for synthesis gas generation”; US Patent; U.S. Pat. No. 7,767,619 B2; Aug. 3, 2010.
11. Sang-Eon Park; Ki-Won Jun; Hyun-Seog Roh; Seung-Chan Back; Young-Sam Oh; Young-Soon Baek; Ri-Sang Choi; Taek-Yong Song; “Modified ⊖-alumina-supported nickel reforming catalyst and its use for producing synthesis gas from natural gas”; US Patent; U.S. Pat. No. 6,808,652 B2; Oct. 26, 2004.
12. Sang-Eon Park; Ki-Won Jun; Hyun-Seog Roh; Seung-Chan Back; Young-Sam Oh; Young-Soon Baek; Ri-Sang Choi; Taek-Yong Song; “Nickel based catalyst using hydrotalcite-like precursor and steam reforming reaction of LPG”; US Patent; U.S. Pat. No. 8,206,576 B2; Jun. 26, 2012.
13. Shakeel Ahmed; Aadesh Harale; Mohammed Albuali; Kunho Lee; Sai P. Katikaneni; Mohammed Draze; “High Activity Reforming Catalyst Formulation and Process for Low Temperature Steam Reforming of Hydrocarbons to Produce Hydrogen”; United States Patent Application Publication; US 2021/0197178 A1; Jul. 1, 2021.
14. Kimihito Suzuki; Kenichiro Fujimoto; “Catalyst for reforming tar-containing gas, method for preparing catalyst for reforming tar-containing gas, method for reforming tar-containing gas using catalyst for reforming tar containing gas, and method for regenerating catalyst for reforming tar-containing gas”; US Patent; U.S. Pat. No. 9,393,551 B2; Jul. 19, 2016.
15. Terry Marker; Martin B. Linck; Jim Wangerow, Pedro Ortiz-Toral; “Noble metal catalysts and processes for reforming of methane and other hydrocarbons”; United States Patent Application Publication; US 2021/0171345 A1; Jun. 10, 2021.
16. Aghaddin Mamedov; “Integration of syngas production from steam reforming and dry reforming”; United States Patent Application Publication; US 2017/0320730 A1; Nov. 9, 2017.
17. Mina Zarabian, Pedro Pereira Almao; “Apparatus and method for producing carbon nanofibers from light hydrocarbons”; International Publication Number; WO 2020/154799 A1; Aug. 6, 2020.

What is claimed is:

1-37. (canceled)

38. A process for production of hydrogen, the process comprising:
reacting hydrocarbons, including methane, and water in a presence of a steam reforming catalyst within a reaction chamber at temperatures less than 550° C. to produce carbon dioxide and hydrogen;
wherein the steam reforming catalyst comprises:
active particles of a mixture of non-noble transition metals, alkaline earth metals and rare earth metals, the active particles having a nanocrystalline structure with domain sizes less than 25 nm, and
a solid oxide support, and
wherein the reaction is controlled such that a number ratio between the produced carbon dioxide to an unreacted methane exiting the reaction chamber is between 0.9 and 1.1.

39. The process according to claim 38, wherein the hydrogen is separated from the other products and unreacted reactants, and the mixture of carbon dioxide and methane is passed unto a second process to produce carbon nanofibers or petrochemicals.

40. The process according to claim 38, wherein the reforming catalyst comprises a solid support selected from the group consisting of alumina, silica, zirconia or mixtures thereof.

41. The process according to claim 40, wherein solid oxide support makes up between 45% and about 90%, by mass, of a total weight of the catalyst.

42. The process according to claim 38, wherein the steam reforming catalyst comprises a non-noble transition metal selected from nickel, cobalt, copper, manganese, iron or mixtures thereof.

43. The process according to claim 42, wherein at least a portion of the non-noble transition metals are oxidized, and a total mass of nickel oxides, cobalt oxides, copper oxides, manganese oxides or iron oxides makes up between 1% and 20%, by mass, of a total weight of the catalyst.

44. The process according to claim 38, wherein the steam reforming catalyst comprises an alkali earth metal.

45. The process according to claim 44, wherein the alkali earth metal comprises a combination of one or more of: magnesium, calcium, strontium and barium.

46. The process according to claim 44, wherein oxides of the alkali earth metal make up between 2% to 30%, by mass, of a total weight of the catalyst.

47. The process according to claim 38, wherein the steam reforming catalyst comprises a rare earth metal.

48. The process according to claim 47, wherein the rare earth metal comprises a combination of one or more of: cerium and lanthanum.

49. The process according to claim 47, wherein oxides of the rare earth metal make up between 5% and 35%, by mass, of a total weight of the catalyst.

50. The process according to claim 38, wherein the catalyst and process are configured to convert a greater proportion of ethane and propane than of methane.

51. A steam reforming catalyst comprising:
a solid oxide support; and
active particles mounted on the solid oxide support, the active particles comprising a mixture of non-noble transition metals, alkaline earth metals and rare earth metals, the active particles having a nanocrystalline structure with domain sizes less than 25 nm.

52. A method of preparation of the catalyst according to claim 51, the method comprising:
providing the solid oxide support; and
providing the active particles of a mixture of non-noble transition metals, alkaline earth metals and rare earth metals, the active particles having a nanocrystalline structure with domain sizes less than 25 nm.

53. The method according to claim 52, wherein, the method comprises:
providing the solid oxide support;
providing a solution precursor of a rare earth metal to the solid oxide support;
thermally treating the solution precursor to provide a modified surface on the solid oxide support; and
providing the active particles on the modified surface.

54. The method according to claim 53, wherein the active particles are provided by:
treating the modified surface of the oxide support with a solution of a mixture of salts, the salts comprising a non-noble transition metal, an alkali earth metal and a rare earth metal combined; and
thermally treating the mixture of salts to produce the active particles.

55. The method according to claim 54, wherein the steps of treating the surface with the solution of the mixture of salts and thermal treatment are repeated to build up multiple layers of active particles.

56. The method according to claim 52, wherein the method comprises activating the active particles with a reducing agent.

57. A process for production of hydrogen, the process comprising:
reacting hydrocarbons, including methane, and water in a presence of a steam reforming catalyst within a reaction chamber at temperatures less than 550° C. to produce carbon dioxide and hydrogen;
wherein the steam reforming catalyst comprises:
active particles of a mixture of non-noble transition metals, alkaline earth metals and rare earth metals, the active particles having a nanocrystalline structure with domain sizes less than 25 nm, and
a solid oxide support.
